(19) United States
(12) Patent Application Publication
(10) Pub. No.: US 2016/0091282 A1
(43) Pub. Date: Mar. 31, 2016

(54) MOBILE BALLISTICS PROCESSING AND TARGETING DISPLAY SYSTEM

(71) Applicants: Joe D. Baker, Richardson, TX (US); Jeffrey P. Barstad, McKinney, TX (US)

(72) Inventors: Joe D. Baker, Richardson, TX (US); Jeffrey P. Barstad, McKinney, TX (US)

(21) Appl. No.: 14/676,082

(22) Filed: Apr. 1, 2015

Related U.S. Application Data
(63) Continuation-in-part of application No. 14/599,894, filed on Jan. 19, 2015.
(60) Provisional application No. 62/088,244, filed on Dec. 5, 2014.
(60) Provisional application No. 61/973,267, filed on Apr. 1, 2014.
(60) Provisional application No. 62/023,147, filed on Jul. 10, 2014.

(51) Int. Cl. F41G 3/16; H04N 5/232; H04N 7/18

(52) U.S. Cl. CPC F41G 3/165; H04N 7/18; H04N 5/23293

(57) ABSTRACT

A mobile ballistics processing and targeting display system for receiving data associated with one or more ballistics variables, for processing such variables, and for displaying an intuitive targeting solution. One or more ballistics variables are inputted into a mobile computing device or are otherwise acquired by such device. Projected in-flight projectile characteristics are calculated by the computing device based upon ballistics variables. A mobile computer processing device having an image collection sensor and display mounted to an optical sight provides a user with the ability to easily view targeting solutions with reference to the sight picture viewable through the sight. The targeting solution displayed to the user is capable of continuous updating to account for changing environmental conditions affecting the calculation of a ballistics solution.

### CROSS REFERENCE TO RELATED APPLICATIONS

This application is a continuation-in-part of U.S. patent application Ser. No. 14/599,894, filed on Jan. 19, 2015, which claims the benefit of U.S. Provisional Application No. 62/088,244, filed Dec. 5, 2014. This application further claims the benefit of U.S. Provisional Application No. 61/973,267, filed on Apr. 1, 2014, and U.S. Provisional Application No. 62/023,147, filed on Jul. 10, 2014. The disclosures made in each of the foregoing applications to which benefit is claimed are incorporated by reference herein.

### BACKGROUND OF THE INVENTION

1. Technical Field

The present invention relates generally to the electronic processing and display of projectile ballistics solutions and more specifically, to systems and methods for processing and displaying a real-time targeting solution to a user using a mobile computer processing device that is configured to be removably attached to an optical sighting device.

2. Description of Related Art

Projectile ballistics processing, involving both computer calculations and calculations performed by persons without the aid of a computing device, is known in the art. In the earliest years of mankind, projectile ballistics solutions were calculated by people using their instinctual knowledge of the laws of motion that they observed in day-to-day life. As time progressed, humans gained further knowledge concerning the laws of motion and the various variables that affect projectile trajectories, allowing them to make ever-increasingly more complex ballistics calculations that resulted in them achieving greater accuracy.

With the invention and widespread adoption of electronic computing devices, capable of performing many billions of calculations per second, it became possible to calculate ballistics solutions, even involving numerous variables changing over time and space, in very compressed time periods. Moreover, as the physical size of computing devices decreased over time, it became possible to utilize mobile personal computers to perform such calculations in the field. Such electronic calculation of ballistics solutions has useful applications in numerous fields including, just by way of limited examples, astrodynamics, forensic analysis, missile guidance, and firearms marksmanship. As discussed further below, the teachings herein are applicable with respect to all manner of ballistics. However, for the purposes of describing the inventions claimed herein, exemplary embodiments will be explained in the context of a mobile computing device capable of electronically calculating and displaying bullet ballistics involving the use of a firearm operated by a single user/shooter. It is contemplated that in alternate embodiments, two or more users could simultaneously utilize the mobile ballistics processing and display system taught herein.

In prior art applications capable of processing ballistics solutions in connection with the use of firearms projectiles, such applications typically utilize a plurality of variables affecting bullet trajectory. A ballistics solution is typically then calculated with reference to a particular shooter's initial calibration of a firearm for a particular bullet. For example, if a shooter's rifle, using a particular bullet/cartridge and a particular optic or other sighting device mounted on the firearm, is configured to be “zeroed” (meaning that the point of impact of the bullet on a target is the same location as the line of sight of the rifle at the target (“aim point”)) at a predetermined “zero” range between the shooter and the target, prior art ballistics solutions typically provide distances (with respect to the target) by which the firearm operator may adjust the line of sight such that the actual point of impact of the bullet will be as desired at distances greater or lesser than the aforementioned “zero” distance. Such adjustments are typically made by physically moving the aim point as seen through a firearm optic sight but may also be made by modifying the firearm optics.

Such physical adjustments to the aim point (commonly called “hold over” and “hold under”) are typically expressed in terms of “up” and “down” with respect to elevation adjustments, and “left” and “right” with respect to windage adjustments. Such adjustments are typically expressed in units such as inches, centimeters, minutes of angle (MOA) and milliradians (Mil). Prior art systems for calculating ballistics solutions typically display such adjustments in numeric form alone for a particular distance to target, or in the form of a ballistics table showing adjustments and/or bullet characteristics for a multitude of target distances. In some prior art ballistics solutions systems, such adjustments for a particular distance to target are displayed within a firearm optic so as to be visible to the shooter.

While prior art electronic systems for calculating and displaying ballistics solutions and targeting solutions offer some advantages, especially as compared to ballistics calculation and targeting methods employed without the use of computing devices, there are many drawbacks and other limitations inherent in such prior art systems. One drawback of such prior art electronic systems is that they fail to display accurate real-time geographic information pertaining to the shooter's surroundings, which would provide a shooter with increased information regarding his or her location, the location of target(s), and the location of other objects or terrain features in the field that could aid in more accurate bullet placement, and/or assist in identifying alternate shooting locations that might provide for more ideal conditions from which to take a shot. Another drawback of prior art electronic systems for processing and displaying ballistics solutions is that they fail to display a graphical representation of approximate in-flight bullet characteristics (including such bullet characteristics with reference to predetermined user criteria/variables) to a shooter in an easily and quickly comprehensible format. Another drawback of prior art targeting display systems is that the calibration of such systems often require the user to input the dimensions of objects in the field of view of the system, which in many scenarios is unknown or if known, only a rough approximation.

Accordingly, a long-felt but unaddressed need in the prior art is for a mobile ballistics processing and targeting display system that provides users with accurate real-time geographic information pertaining to the user's surroundings. Another long-felt but unaddressed need in the prior art is for an electronic ballistics processing and targeting display system that displays a graphical representation of approximate in-flight bullet characteristics (including such bullet characteristics with reference to predetermined user criteria/variables) to a shooter in an easily and quickly comprehensible format. Another long-felt but unaddressed need in the prior art is for an electronic ballistics processing and targeting display system that allows for accurate calibration by utilizing readily ascertainable dimensions of an optical sight with which the system is utilized. As described in further detail below, the inventions disclosed herein provide these and other long-felt but unmet needs in the art.

### BRIEF DESCRIPTION OF THE SEVERAL VIEWS OF THE DRAWINGS

The novel features believed characteristic of the inventions are set forth in the appended claims. The inventions themselves, however, as well as preferred modes of use, further advantages thereof, will be best understood by reference to the following detailed description of illustrative embodiments when read in conjunction with the accompanying drawings, wherein:

FIG. 1 is a process flow diagram illustrating steps performed by an embodiment of the mobile ballistics processing and display system;

FIG. 2 is a block diagram of an embodiment of a mobile computing device on which exemplary processes of an embodiment of the mobile ballistics processing and display system can be executed;

FIG. 3 is a network diagram showing an embodiment of a mobile ballistics processing and display system and other devices with which it is in communication according to one embodiment of the invention;

FIG. 4 illustrates a screenshot of a display of an embodiment of the mobile ballistics processing and display system, said display showing geographic information, ballistics solutions, representations of approximate in-flight bullet characteristics, and menu options available to a user;

FIG. 5 shows a block diagram representing a main menu map of a software application executed by an embodiment of the mobile ballistics processing and display system;

FIG. 6 shows a process flow diagram associated with the “Armory” icon included in a software application executed by an embodiment of the mobile ballistics processing and display system;

FIG. 7 shows a process flow diagram associated with the “Weather” icon included in a software application executed by an embodiment of the mobile ballistics processing and display system;

FIG. 8 shows a block diagram menu map associated with the “Extended Menu” icon included in a software application executed by an embodiment of the mobile ballistics processing and display system;

FIG. 9 further illustrates a screenshot of a display of an embodiment of the mobile ballistics processing and display system, said display showing geographic information, ballistics solutions, representations of approximate in-flight bullet characteristics, and menu options available to a user as shown at FIG. 4;

FIG. 10 illustrates an embodiment of graphical representations of approximate in-flight bullet characteristics as displayed by an embodiment of the mobile ballistics processing and display system;

FIG. 11 illustrates a screenshot of a display of an alternate embodiment of the mobile ballistics processing and display system, said display showing graphical representations of boundaries around a target, projecting geographic areas where a projectile will meet, exceed and/or fall below defined in-flight projectile characteristics criteria based on ballistics processing by said mobile ballistics processing and display system;

FIG. 12 illustrates a screenshot of a display of an embodiment of the mobile ballistics processing and display system, said display showing a ballistics table on which data resulting from ballistics solution processing is displayed;

FIG. 13 is a block diagram illustrating exemplary components of a further embodiment of a mobile computer processing device configured to implement the features of the mobile ballistics processing and display system;

FIG. 14 illustrates a perspective view of an embodiment of a mobile computer processing device on which exemplary processes of an embodiment of the mobile ballistics processing and display system can be executed, said mobile computer processing device being mounted adjacent to the eyepiece of an optical spotting scope;

FIG. 15 illustrates a perspective view of the embodiment of the mobile computer processing device and spotting scope shown in FIG. 14, said mobile computer processing device mounted on said spotting scope via one embodiment of a mounting adapter;

FIG. 16 illustrates a perspective view of an embodiment of a mobile computer processing device on which exemplary processes of an embodiment of the mobile ballistics processing and display system can be executed, said mobile computer processing device being mounted adjacent to the eyepiece of a rifle scope;

FIG. 17 illustrates a screenshot of a display of an alternate embodiment of the mobile computer processing device of the mobile ballistics processing and display system as mounted on an optical sight, said display showing a reticle of the optical sight, and other graphical representations configured for facilitating the calibration of the system;

FIG. 18 illustrates a screenshot of a display of the alternate embodiment of the mobile computer processing device of the mobile ballistics processing and display system as mounted on an optical sight as shown in FIG. 16, said display showing a reticle of the optical sight, and other graphical representations configured for facilitating the calibration of the system;

FIG. 19 illustrates a screenshot of a display of the alternate embodiment of the mobile computer processing device of the mobile ballistics processing and display system as mounted on an optical sight as shown in FIG. 16, said display showing a graphical representation of the point of impact according to a targeting solution processed by the system, said point of impact displayed adjacent to a display of a reticle of the optical sight; and

FIG. 20 is a process flow diagram illustrating steps performed by an embodiment of the mobile ballistics processing and display system for the processing and display of a targeting solution.

Where used in the various figures of the drawings, the same reference numerals designate the same or similar parts. All figures are drawn for ease of explanation of the basic teachings of the invention only; the extensions of the figures with respect to number, position, relationship, and dimensions of the parts to form the preferred embodiment will either be explained or will be within the skill of persons of ordinary skill in the art after the following teachings of the present invention have been read and understood.

### DETAILED DESCRIPTION OF THE DRAWINGS

Several exemplary embodiments of the claimed invention(s) will now be described with reference to the drawings. Unless otherwise noted, like elements will be identified by identical numbers throughout all figures. The invention(s) illustratively disclosed herein suitably may be practiced in the absence of any element that is not specifically disclosed herein.

Systems and methods for processing and displaying ballistics and targeting solutions via a computing device are disclosed herein. It should be noted that while the exemplary embodiments described herein are associated with bullet trajectories, the systems and methods taught below could also be equally utilized in connection with other types of projectiles, regardless of the source of the force that propels such projectiles into motion or sustain them in flight.

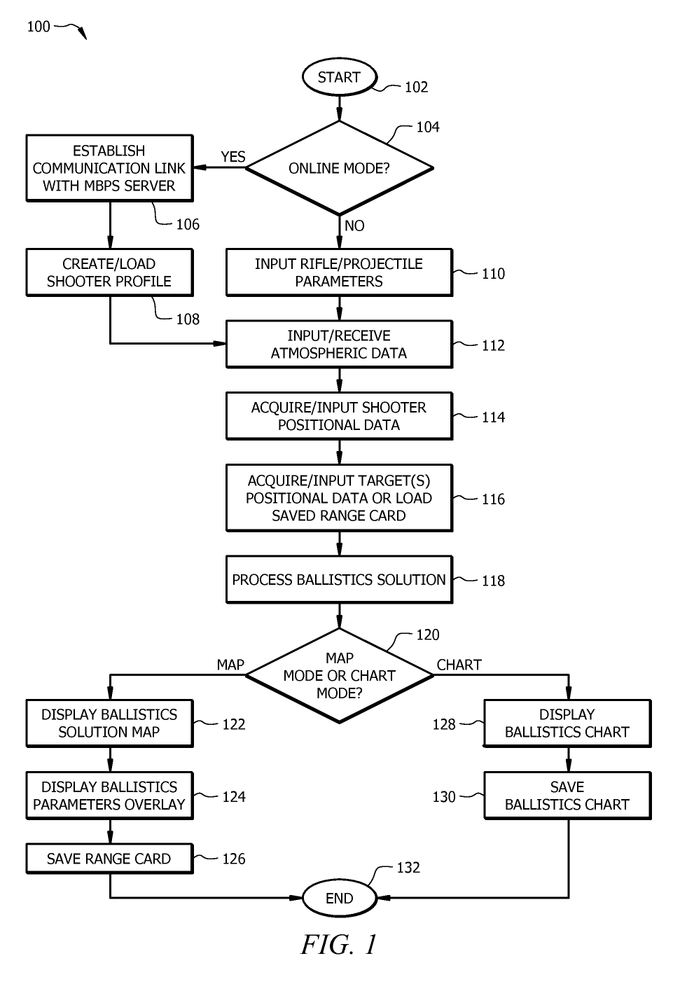

Referring now to FIG. 1, a process flow diagram 100 illustrating steps performed by an embodiment of the mobile ballistics processing and targeting display system (hereinafter, “MBPDS”), the MBPDS provides one or more users with a mobile computing device for calculating ballistics solutions for one or more targets based on a plurality of ballistics variables, displays real-time geographic information to users, and further displays representations of approximate in-flight bullet characteristics in conjunction with said geographic information. It should be noted at the outset that the steps appearing in the process flow diagram shown in FIG. 1 are but one example of the ordering of steps that may be taken by a user and/or by the MBPDS to provide the ballistics processing and display claimed herein. The ordering of steps shown in FIG. 1 is not essential to the invention and may be altered in the preferred embodiments shown or other alternate embodiments of the MBPDS, without altering the underlying concepts taught herein.

In one embodiment of the MBPDS, a user will interface with the system via a graphical user interface (GUI) and, as further discussed in greater detail below, the user will be provided with an option 104 to utilize the MBPDS in an online mode by establishing a communications link via a communications network, or alternatively have the option to utilize the system in an offline mode.

If the user chooses to utilize the MBPDS in an online mode, the MBPDS computing device executing a software application will attempt to establish 106 a communications link with a MBPDS server. If a communications link is successfully established, the user will be prompted to create a MBPDS account or, if such an account has previously been established by the user, the user will be prompted to provide authenticating information such as a login name and password so that the MBPDS server can verify the identity of the particular user. If the user is successfully authenticated by the MBPDS server, the user will be given the option to download one or more previously created shooter profile(s) into the MBPDS computing device. In one embodiment of the MBPDS, and as described in further detail below, a shooter profile may comprise information relating to all or part of the ballistics variables needed for accurate ballistics solution processing. Such ballistics variables that may comprise a profile may include bullet parameters and rifle setup information as described further below.

Still referring to FIG. 1, if a user chooses to utilize the MBPDS in offline mode, the user will be provided with a menu icon (or prompted) to manually input 110 information relating to ballistics variables needed for ballistics solution processing. A user operating the MBPDS computing device in offline mode will still be given the option to manually input ballistics variables such as bullet parameters and rifle setup information.

In one embodiment, the MBPDS will store in a database (alternatively referred to herein as a “bullet library”) information relating a plurality of different cartridges/bullets of various calibers, bullet weights, and bullet types. As an alternative to manually inputting bullet ballistics information into the MBPDS, users will preferably be provided an option to search for particular cartridges/bullets that the user plans to shoot during a range session. If a desired cartridge/bullet that is being shot by the user is found within the bullet library database, the information relating to ballistics variables for that bullet that is stored within the library database may be loaded for use in ballistics solution processing by the MBPDS. The user will be further prompted to input additional information relating to other ballistics variables (information relating to rifle setup and optionally, information relating to spin drift and line of sight angle,) as described in further detail below.

The MBPDS will be further configured to receive atmospheric information 112 for further use in more accurately predicting bullet trajectories. One or more atmospheric sensors such as, for example, a wind speed/direction sensor, a temperature sensor, a pressure sensor, and a relative humidity sensor, will be preferably connected to or otherwise integrated into the MBPDS computing device so as to provide real-time atmospheric data to the system for use in ballistics solution processing. The MBPDS will further be configured to optionally receive atmospheric data from a weather server, for use in ballistics solution processing. The MBPDS will even further be configured to provide for the manual input of atmospheric data by a user.

Next, geographical information relating to positional data associated with the user and one or more targets is acquired from remote positional data sources or manually inputted by the user 114. In either online or offline mode, a GPS transceiver in communication with the MBPDS will acquire positional data (for example, map coordinates and elevation) associated with the location of the MBPDS computing device from one or more GPS satellites or other navigational aids (for example, LORAN, Wi-Fi network, etc.). When the MBPDS is operated in online mode, the MBPDS will transmit, via a communications network, such positional data associated with the MBPDS computing device to a geographic information systems server, and from such server, receive map data associated with the device location to display on the MBPDS computing device. At a predetermined frequency of time, the MBPDS is configured to request and receive updated map data from the geographic information systems server, and utilize such map data to refresh the map display. When the MBPDS is operated in offline mode, map data stored in the MBPDS computing device or connected storage device, will be accessible for use and displayable to the user.

The MBPDS user will be provided with the ability to manually identify his or her shooting position on the map. An input device such as a touchscreen interface integrated into the MBPDS display, will provide the user with the ability to identify his or her location on the map display using a finger or pointing device. Coordinate data associated with the map pinpoint indicated by the user on the map display will be utilized in calculating one or more ballistics solutions. Alternatively, the MBPDS system will be configured to automatically approximate the shooter's position using GPS positional data, and to represent such approximate position on the map display.

Next, the user will be provided with the ability to manually or automatically identify the location(s) of one or more targets 116. An input device such as a touchscreen interface integrated into the MBPDS display, will provide the user with the ability to identify the location of one or more targets on the map display using a finger or pointing device. Alternatively, the MBPDS system is configured to automatically approximate the location of one or more targets using GPS positional data, and to represent such approximate position on the map display. In one embodiment, the user will transport the MBPDS computing device to the target(s) location(s) before automatically acquiring positional data associated with a particular target.

In alternate embodiments, the MBPDS will be configured to automatically approximate the position of one or more targets by utilizing data acquired from other connected electronic input devices such as, for example, a laser range finder and a compass. Such input devices may be integrated into the MBPDS computing device or may be configured to communicate data to the computing device (for example, via Bluetooth transmission). From such range and directional information, those of skill in the art will realize that it will be possible for the MBPDS computing device to calculate approximate positional locations of distant targets without the need to physically move to such locations.

For example, in one embodiment, a rangefinder may be utilized to ascertain data associated with the range and direction of one or more targets with respect to the location of the rangefinder. A communication link (for example, via Bluetooth, WiFi, cellular network, infrared, etc.) may be established between the rangefinder and a MBPDS computing device. Once ascertained, such data associated with the range and direction of one or more targets with respect to the location of the rangefinder may be transmitted from the rangefinder to the MBPDS computing device. Using such range and directional information pertaining to the target location, the MBPDS computing device may, using principles of vector analysis, calculate a location of the target with respect to the MBPDS computing device. The MBPDS computing device will store such target location into memory, and may optionally represent such target location on a map display as discussed above. From such target location information derived from the rangefinder, and using further ballistics variable as discussed herein, the MBPDS may calculate a ballistics solution for the user.

It should be noted that in some alternate embodiments, a rangefinder may be used in conjunction with an MBPDS computing device from a location remote from the MBPDS computing device. In such a scenario, the rangefinder may further ascertain the location of the MBPDS computing device (using GPS information received from the MBPDS device or by acquiring range and directional information pertaining to the location of the MBPDS device with respect to the rangefinder) and use such information to triangulate, using vector analysis principles, the location of the target with respect to the MBPDS computing device. This target location information may then be transmitted, via a communications link, to the MBPDS computing device. Alternatively, such triangulation calculations may be performed at the MBPDS computing device, using range/directional information acquired by and received from the rangefinder.

In further alternate embodiments, the MBPDS will be configured to store one or more “range cards” containing prepopulated positional data associated with one or more shooter locations and/or one or more target locations. In such alternate embodiments, the user will be provided with the ability to load such range cards for continued use. If a range card is loaded for use, shooter location(s) and target location(s) will be displayed on the display map accessible to the user on the MBPDS computing device.

Still referring to FIG. 1, the MBPDS in this embodiment is configured to process 118 one or more ballistics solutions with respect to the user/shooter location and each of the one or more targets selected. More specifically, a central processor unit of the MBPDS is configured to process data associated with one or more ballistics variables associated with a projectile to generate data associated with projected in-flight characteristics corresponding to said projectile. In processing one or more ballistics solutions, the MBPDS is configured to calculate the trajectory of the bullet used by the user/shooter by taking into account the effect of the ballistics variables associated with the projectile (in this embodiment, a bullet) inputted or otherwise acquired/loaded by the user, as well as the positional data associated with the shooter and target as inputted by the user or as otherwise acquired/loaded by the MBPDS. The MBPDS will also preferably process one or more ballistics solutions by taking into account atmospheric data such as wind speed/direction, temperature, relative humidity, atmospheric pressure, and other ballistics variables such as elevation/altitude. The processing of ballistics solutions will, in one embodiment, will take place locally in one or more processors found in the MBPDS computing device using known methods for making such calculations. In alternate embodiments, ballistics solution processing may occur remotely at a MBPDS server or other third party server upon the establishment of a communications link to transmit and receive information relating to ballistics variable and ballistics solutions.

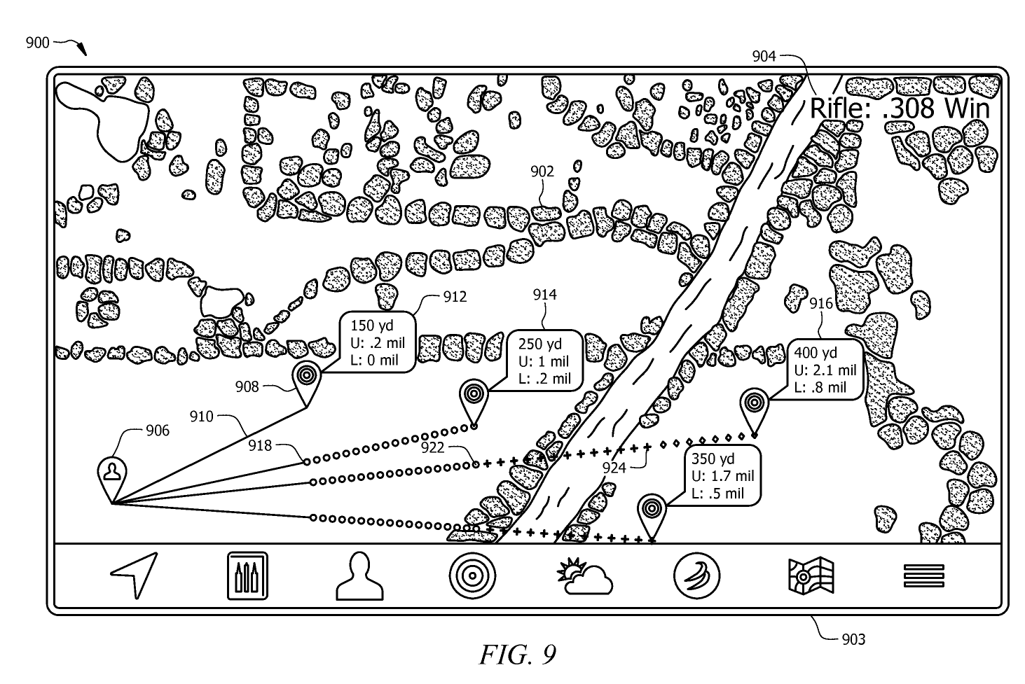

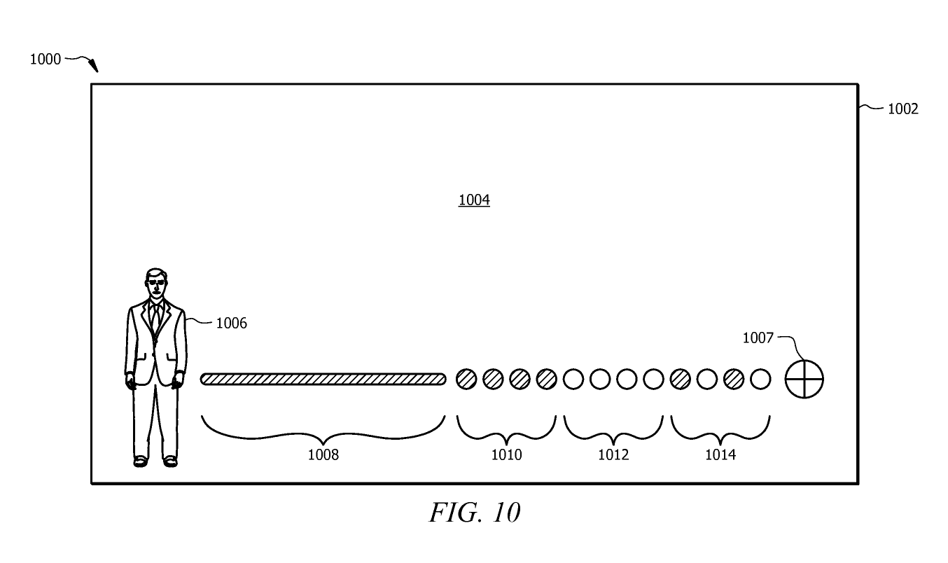

In one embodiment of the MBPDS, the user will be provided with an option to view the pertinent results of such ballistics solution processing in either a “map mode” or a “chart mode.” In map mode 122, the MBPDS will display, among other items, a ballistics solution map showing the position of the shooter, the position of the one or more targets, the distance between the shooter and target(s), and elevation/windage adjustments (with respect to the “zero” orientation) needed to be made by the shooter to hit the target(s). The MBPDS will also be configured to provide graphical representations of approximate in-flight bullet characteristics in an overlay 124 on the map display, thereby providing the user/shooter with an easily and quickly understandable depiction of where in the bullet's projected path, the bullet's characteristics change with respect to predetermined criteria/variables set by the user as discussed in further detail below with reference to FIG. 9 and FIG. 10. In one embodiment, the MBPDS will provide the user with the ability to save 126 data associated with a map presentation (“range card”) on the MBPDS (or remotely store such data) for future use by himself or herself, or by other third parties. In alternate embodiments of the MBPDS, two or more MBPDS users will be capable of communicating ballistics data, map data, and other data to each other over a network (“squad mode”).

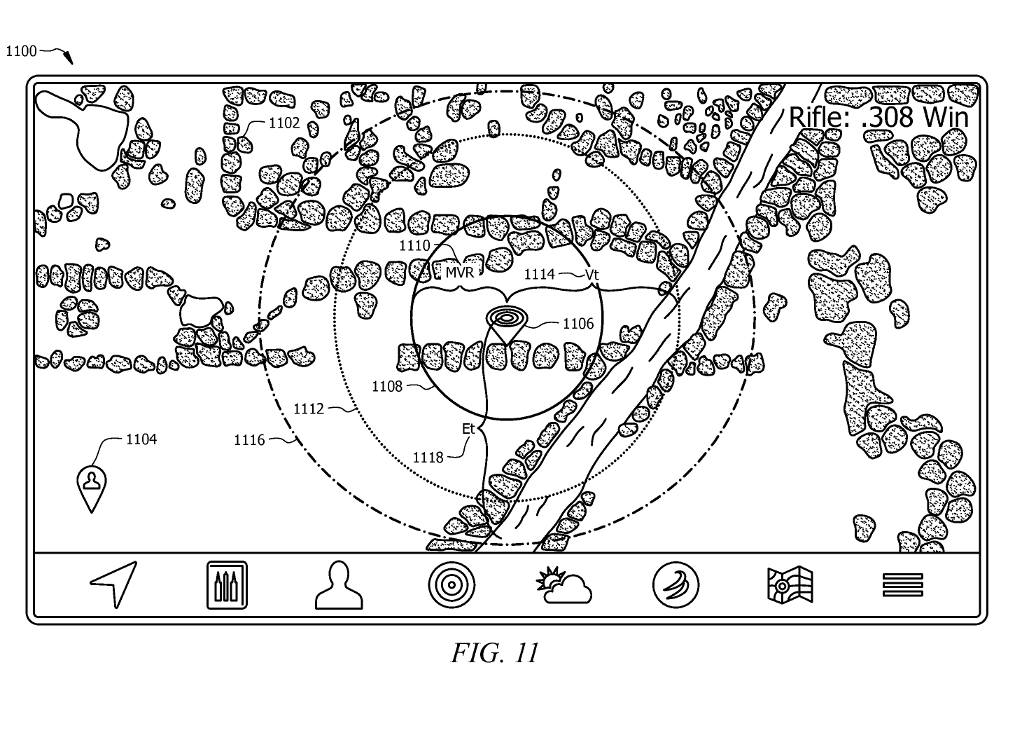

In “chart mode” of the MBPDS, the MBPDS computing device is configured to display ballistics data in the form of a ballistics table. As described in further detail below with reference to FIG. 11, bullet trajectory information, bullet characteristics information (velocity, energy, maximum vital range, maximum point blank range, etc.), and required shooter adjustments (elevation/windage) are displayed to a user on a ballistics table in distance increments between the shooter and the target(s).

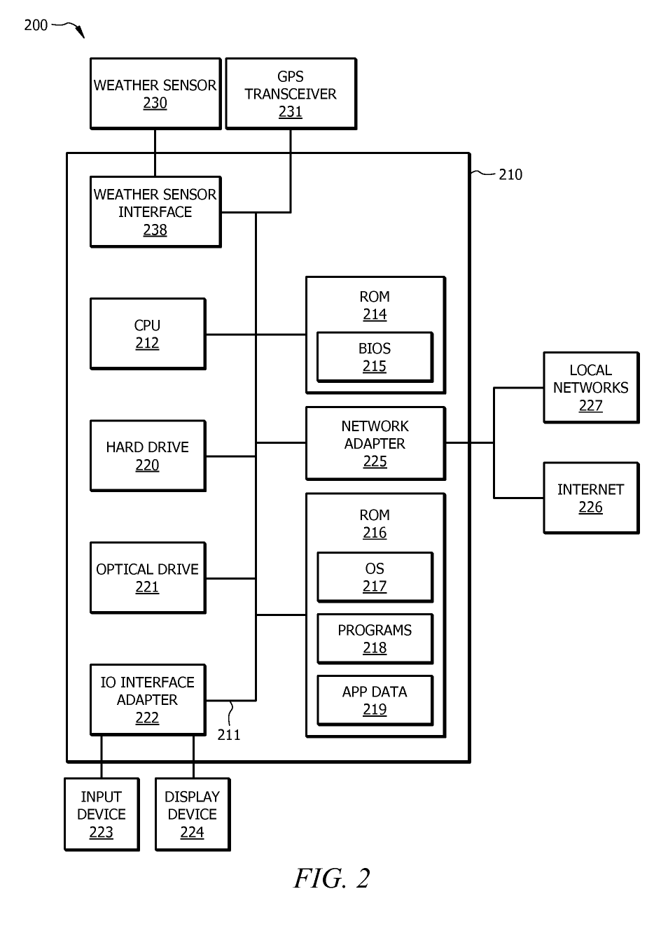

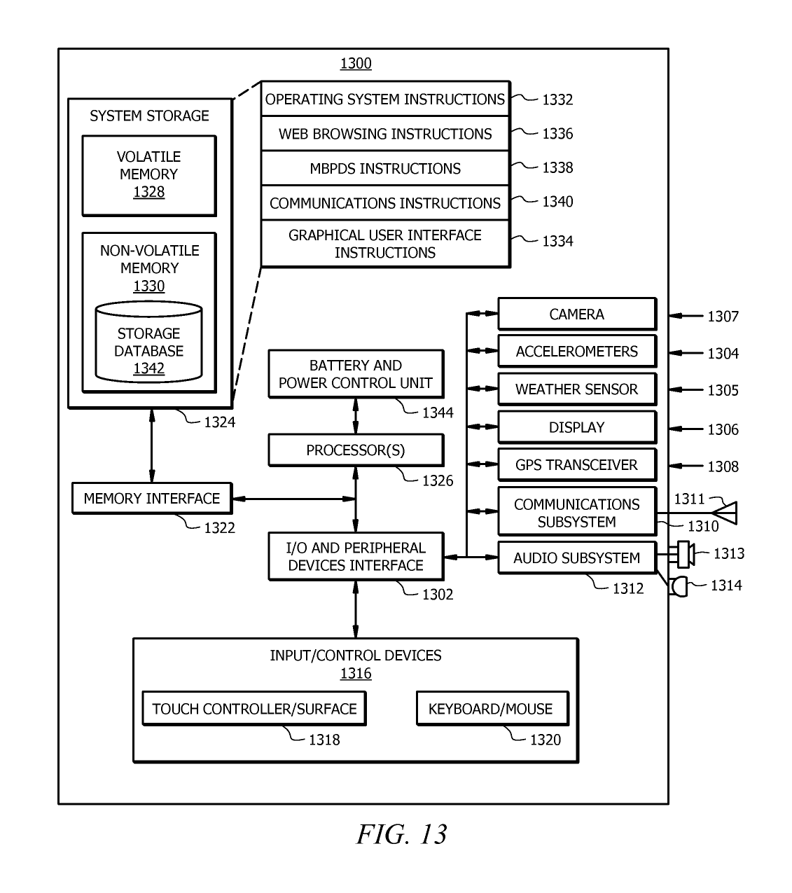

Referring now to FIG. 2, a preferred exemplary block diagram 200 of a computing device 210 on which exemplary processes of the MBPDS can be executed according to one embodiment of the invention. It should be noted that while the preferred embodiment of the MBPDS computing device is a smart phone or tablet device, other types of computing devices such as, for example, laptops and wearable computers (for example, a smart watch) may also be utilized as MBPDS computing devices (an even further embodiment of the computing device of the MBPDS is shown and described below with reference to FIG. 13). In one embodiment, the computing device includes a central processor unit (CPU) 212, read only memory (ROM) 214, random access memory (RAM) 216, and a system bus 211 that couples various system components including the RAM 216 to the processor unit 212. The system bus 211 may be any of several types of bus structures including a memory bus or memory controller, a peripheral bus and a local bus using any of a variety of bus architectures. A basic input/output system 215 (BIOS) is stored in ROM 214. The BIOS 215 contains basic routines that help transfer information between elements within the computing device 210.

The computing device 210 can further include a disk drive 220 for reading from and writing to a hard disk (solid state or platter), an optical disk drive 221 for reading from or writing to a removable optical disk such as a CD ROM, DVD, or other type of optical media. The hard disk drive 220 and optical disk drive 221 can be connected to the system bus 211 by a hard disk drive interface (not shown), flash drive (not shown), and an optical drive interface (not shown), respectively. The drives and their associated computer-readable media provide nonvolatile storage of computer readable instructions, data structures, programs, and other data for the computing device 200.

Although the example environment described herein employs a hard disk drive 220, other types of computer-readable media capable of storing data can be used in the example system. Non-limiting examples of these other types of computer-readable mediums that can be used in the example operating environment include flash memory cards. A number of program modules may be stored on the ROM (214), RAM (216), hard disk drive 220 or optical disk drive 221, including an operating system 217, one or more application programs 218, other program modules, and program (e.g., application) data 219.

A user may enter commands and information into the computing device 210 through input devices 223, such as a keyboard, capacitive touch screen, and/or mouse (or other pointing device). Examples of other input devices 223 may include a microphone, camera, compass, and laser rangefinder. These and other input devices are often communicatively connected to the processing unit 212 through an I/O port interface 222 that is coupled to the system bus 211. Such input devices may be integrated into the computing device or alternatively, communicate with the computing device by known data transfer methods (for example, Bluetooth, infrared light signals, etc.). A screen 224 or other type of display device is also communicatively connected to the central processor unit via the system bus 211 via an interface, such as the IO interface 222. In addition to the display device 224, computing systems typically include other peripheral output devices (not shown), such as speakers and document printers. In one embodiment, the MBPDS computing device 210 may be configured to be in communication with a weather sensor 230 for providing local weather information to the MBPDS for use in processing ballistics solutions. In one embodiment, a GPS transceiver 231 is configured for connection to the MBPDS computing device, said transceiver to process positional information received one or more GPS satellites or other navigational devices.

The computing device 210 may operate in a networked environment using logical connections to one or more remote computing devices (for example, in “squad mode”). The remote computing device may be another MBPDS computing device, smart phone, tablet computer, personal computer, a server, a router, a network PC, a peer device or other common network node, and typically includes many or all of the elements described above relative to the computing device 210. In certain embodiments, the network connections can include a cellular network, Bluetooth, local area network (LAN) or a wide area network (WAN). Such networking environments are commonplace in offices, enterprise-wide computer networks, intranets, and the internet 226.

When used in a WAN networking environment, the computing device 210 typically includes a modem, Ethernet card, or other such means for establishing communications over the wide area network, such as the Internet 226. The modem or other networking components, which may be internal or external, can be connected to the system bus 211 via a network interface or adapter 225. Network adapter 225 may be one or more networking devices that enable computing devices associated with the MBPDS to transmit data in a network with an entity that is external to the server, through any communications protocol supported by the server and the external entity. Network adapter 225 may include, but is not limited to, one or more of a network adaptor card, wireless network interface card, router, access point, wireless router, switch, multilayer switch, protocol converter, gateway, bridge, bridge router, hub, digital media receiver, and/or repeater.

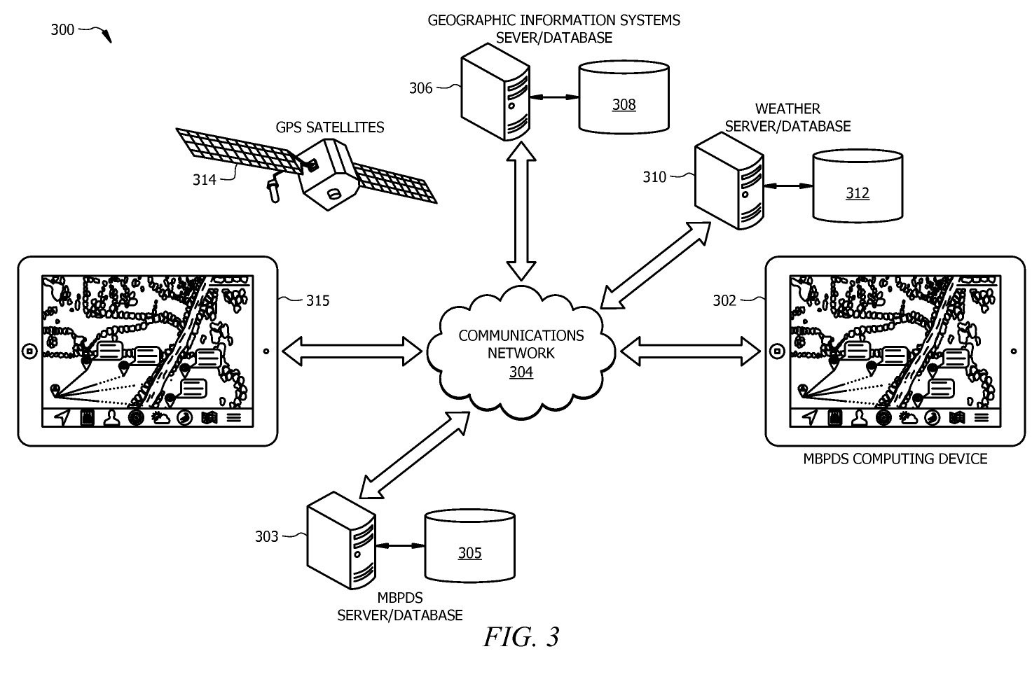

Referring now to FIG. 3, a network diagram 300 showing MBPDS computing device 302 and other devices with which it is in communication according to one embodiment of the invention. The MBPDS computing device 302 is preferably in communication with other networked devices over a cellular network 304 or WAN such as the Internet. A MBPDS server and associated database communicates with the MBPDS computing device, the MBPDS server providing the user with authentication to use the system, previously saved data associated with bullet and rifle setups preferred by the user, and remote processing of ballistics solutions. In alternate embodiments of the MBPDS, ballistics processing is performed using a processor of the MBPDS computing device. GPS satellites 314 receive and transmit positional data to/from the MBPDS computing device via a GPS transceiver connected to the device. A geographic information systems server 306 in communication with the MBPDS computing device (or alternatively, with the MBPDS server, which relays communications to/from the MBPDS computing device), via a communications network, receives coordinate data from the MBPDS server regarding the location of the device, and returns map data associated with such location for display on the MBPDS computing device.

A weather server 310 and associated database 312 is also capable of communicating with the MBPDS computing device (or alternatively, with the MBPDS server, which relays communications to/from the MBPDS computing device), providing atmospheric data used by the MBPDS computing device to in processing ballistics solutions. In alternate embodiments of the MBPDS, the MBPDS computing device will be configured to establish a communications link with one or more other MBPDS computing devices 315, allowing users to communicate positional data and ballistics information amongst one another (“squad mode”). Such communications capabilities between MBPDS computing devices will ideally allow for greater coordination amongst shooters, and for increased range safety as each shooter will know the position of other shooters on the range.

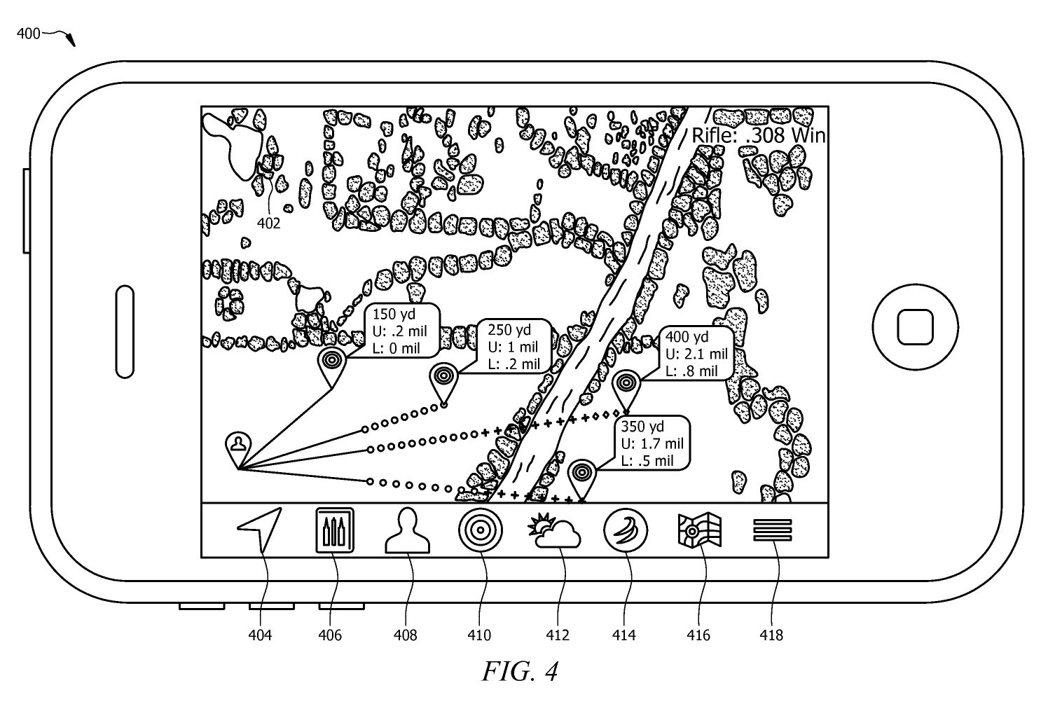

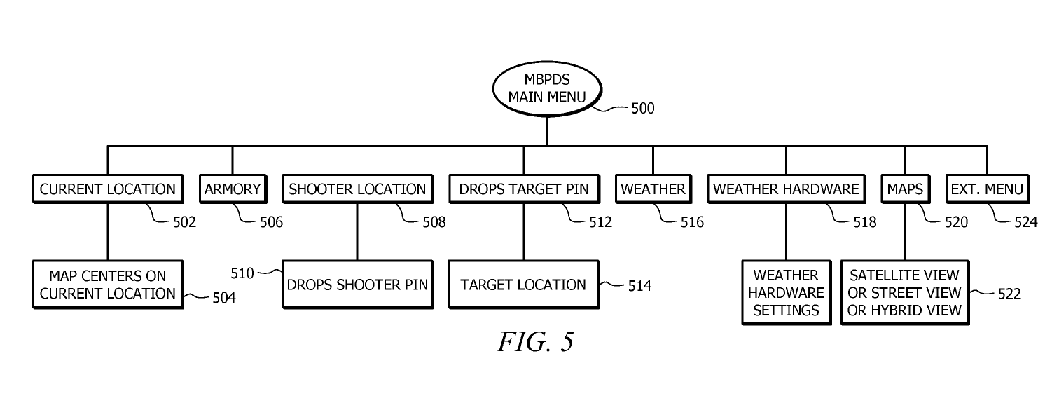

Referring now to FIG. 4, a screenshot 400 of a display 402 of an embodiment of the MBPDS computing device, said display showing geographic information (map features) relating to the locations of the shooter, targets, terrain features, as well as ballistics solutions (distance to target, elevation/windage adjustments), representations of approximate in-flight bullet characteristics (bullet velocity, bullet energy, maximum vital range), and menu icons available to a user. In one embodiment, the GUI of the MBPDS provides users with seven main menu icons, as well as an icon that may be selected to view additional “extended” menu icons. In one embodiment, the MBPDS will be configured to include a touchscreen, allowing a user to select a menu icon with a finger or other pointing device. Different screens will appear on the GUI, depending on the menu icon selected by a user. The types of main menu icons shown in FIG. 4 are solely illustrative of examples of menu items that may be provided to a user to allow them to more easily navigate the available features of the MBPDS. In alternate embodiments of the MBPDS, menu icons may vary by type and number. As discussed in further detail with reference to FIG. 5 below, the main menu icons displayed and available for selection by a user include a location icon 404, armory icon 406, shooter icon 408, target icon 410, weather icon 412, weather hardware icon 414, map icon 416, and an extended menu icon 418.

Referring now to FIG. 5, a block diagram representing a main menu 500 map of a software application executed by an embodiment of the MBPDS. As previously described above with respect to FIG. 4, in one embodiment of the MBPDS, a plurality of menu icons are displayed to a user, thus providing an intuitive means for navigating the software features of the MBPDS. The main menu icons displayed and available for selection by a user include a current location icon 502, armory icon 506, shooter icon 508, target icon 512, weather icon 516, weather hardware icon 518, map icon 520, and an extended menu icon 528. When a main menu icon is selected by a user, the MBPDS will execute an operation without any further prompting of the user and/or will advance to a sub-menu screen and provide additional prompts to the user.

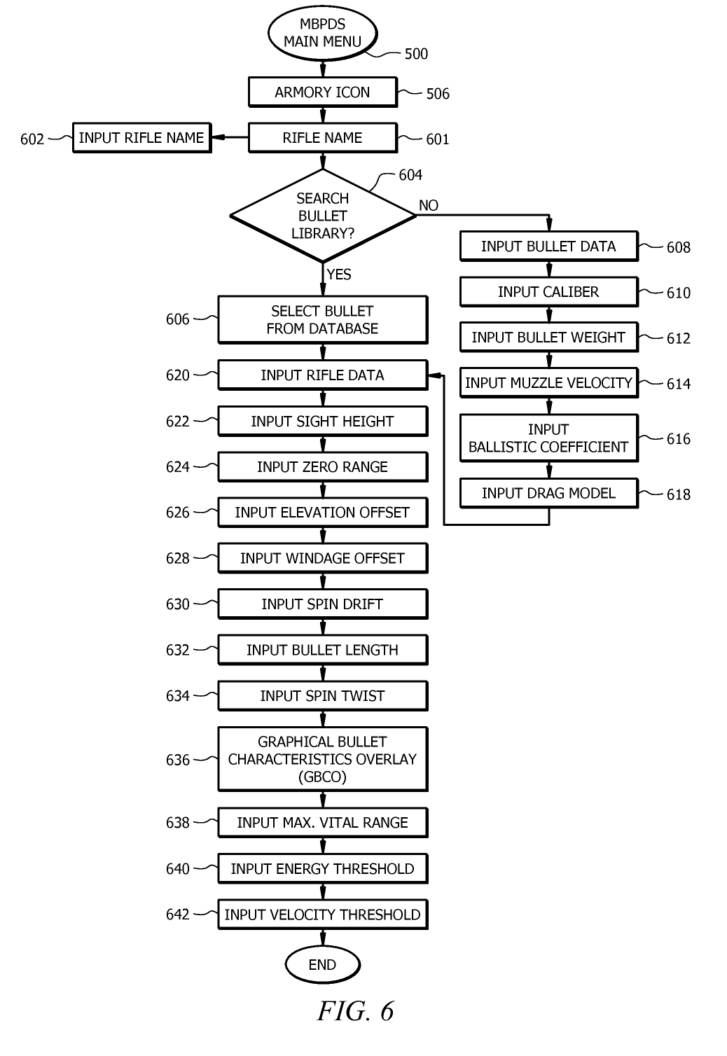

Still referring to FIG. 5, with respect to the current location menu icon 502, selection of the icon will cause the MBPDS map display to center at the then current location of the MBPDS computing device. As described above, this operation will require the MBPDS to acquire positional data from one or more GPS satellites, transmit such positional data to a geographic information systems server, and receive and display map data from such server (map data may also accessed from cache). The armory icon 506, described in further detail with reference to FIG. 6, provides the user with additional sub-menus which can be navigated to input or otherwise acquire ballistics data (bullet attributes, rifle setup, spin drift, etc.) and to further input criteria for in-flight bullet/projectile characteristics (maximum vital range, energy threshold, and velocity threshold).

With respect to the shooter icon 508, selection of this icon by a user will cause a graphical pin to be displayed at the current location of the MBPDS computing device. With respect to the target icon 512, selection of this icon by a user will cause a graphical pin to be displayed at the current location of the MBPDS computing device. The MBPDS will be configure to allow the user, using a touchscreen input device integrated into the MBPDS computing device, to manually identify the location of the shooter and/or one or more targets. Manual input of the geographical location of shooter and target(s) may provide for more accurate positional information in some cases, especially in situations where it is difficult to obtain accurate reception from GPS satellites.

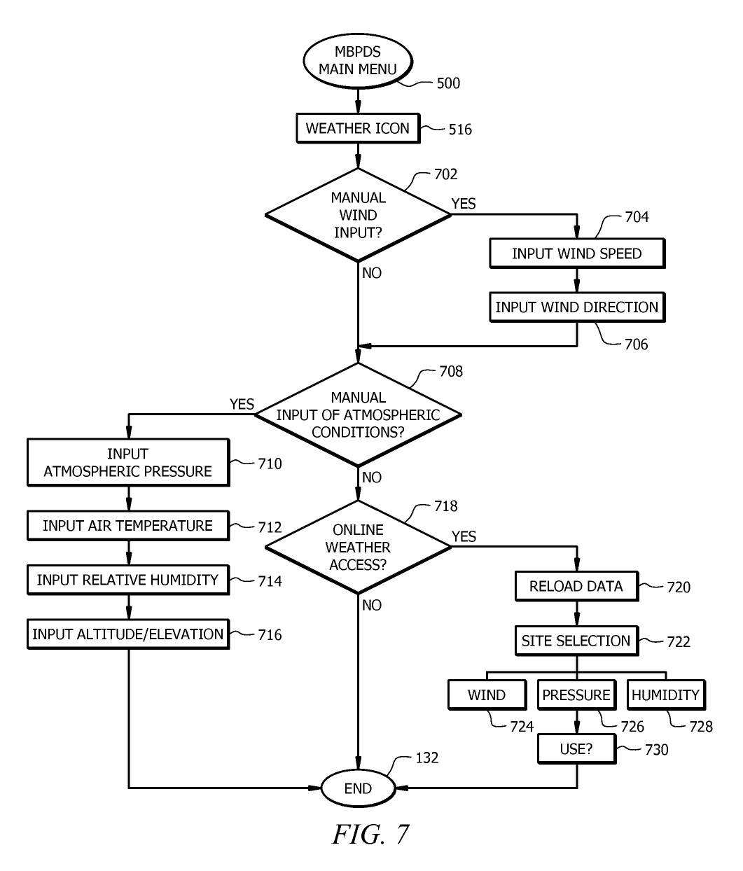

The weather icon 516, described in further detail with reference to FIG. 7, provides the user with additional sub-menus which can be navigated to manually input various weather attributes (wind speed/direction, temperature, atmospheric pressure, humidity, and altitude). Further sub-menus of the weather icon are provided for accessing weather attributes from online sources such as, for example, the weather server discussed with reference to FIG. 3. A weather hardware icon 518 is further provided to acquire weather attributes from an atmospheric sensor that is integrated or otherwise connected to the MBPDS computing device via a wired or wireless connected. The atmospheric sensor (also referred to herein as a “weather sensor”) is configured to collect information relating to one or more weather attributes at the location of the MBPDS computing device, and to transmit such weather information to the MBPDS for use in processing ballistics solutions. In alternate embodiments, the MBPDS may communicate wirelessly with one or more local atmospheric sensors positioned, for example, at the shooting range where the user is located, and utilize atmospheric data collected by such sensor(s) for ballistics processing.

In one embodiment, the MBPDS computing device may be configured to communication with a WeatherFlow® wind meter by utilizing a WeatherFlow® API (provided by WeatherFlow, Inc.) to utilize wind speed/direction data from the wind meter for processing ballistics solutions. In other alternate embodiments, the MBPDS may be configured to communicate and use atmospheric data from other types of atmospheric sensors capable of collecting various types of atmospheric data that may be useful in processing ballistics solutions. One advantage of utilizing an atmospheric/weather sensor in connection with the MBPDS computing device is that the weather information acquired by the sensor is likely to be more accurate than weather data acquired from online sources of weather data. In one embodiment, a wind meter utilized by the MBPDS will be configured to collect wind speed/direction data for a thirty second time period (a “sample”), and calculate average wind speed and wind direction values. Users will be capable of modifying sample collection time, view past saved sample data, and add text descriptions of samples. Further an average wind speed and wind direction value associated with a sample may be deleted, saved, and/or submitted to the MBPDS for further use in ballistics processing. Users of the MBPDS will be provided with an option to manually start and stop collection of weather data.

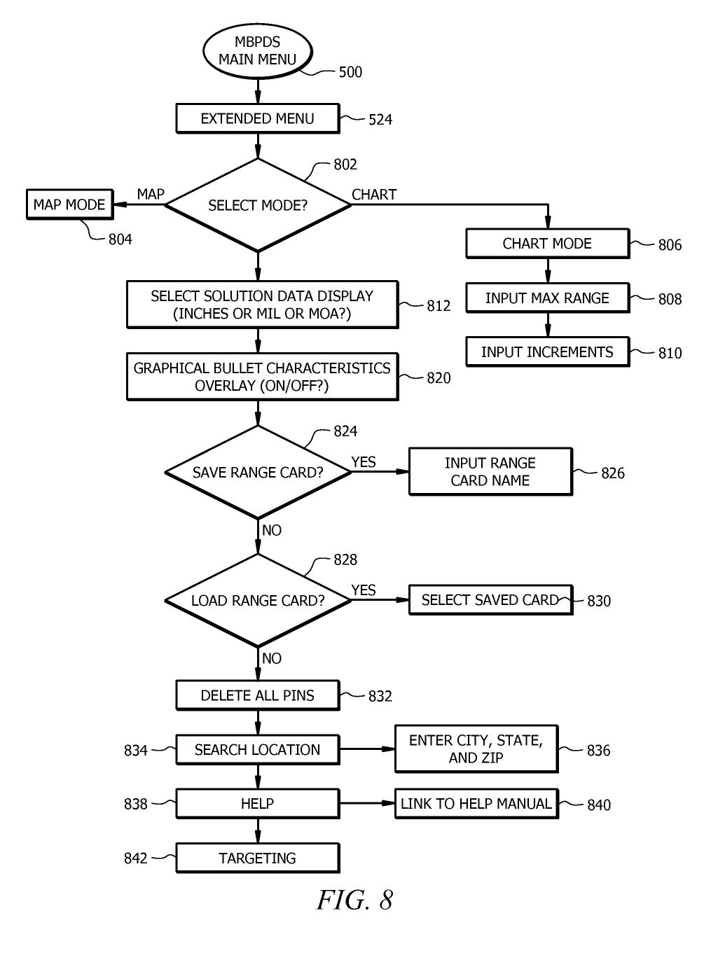

A map icon 520 is displayed to users and allows for the selection of one or more map views. For example, a user may select to view a “satellite view” 522 of the map, which provides what appears to be an overhead aerial view of the terrain surrounding the computing device. Another map viewing option is a “streets view” 522, which displays an overhead view of graphical representations of streets and other roadways surrounding the computing device. Another map viewing option is a “satellite and streets view” 522, which displays a combination of an overhead aerial view that is overlaid with graphical representations of street and other roadways surround the computing device. In one embodiment, map data for display on the MBPDS may be obtained over a communications network from a commercial source for map information such as, for example, Google Maps® provided by Google, Inc. An extended menu icon 524, described in further detail below with reference to FIG. 8, provides users access to various additional sub-menus that allow for modifications to be made to settings and to perform other operations provided by the MBPDS.

Referring now to FIG. 6, a process flow diagram associated with the “Armory” icon 506 included in a software application executed by an embodiment of the MBPDS. Under the armory icon, users are provided with a process for inputting various information affecting the processing of ballistics solutions. A “Rifle Name” step 601 is provided, providing users with the ability to input 602 a rifle “name” or “profile,” which will contain the ballistics information associated with a particular rifle/bullet combination. Users will be provided with a “Search Bullet Library” step 604 that will enable them to search a ballistics database (stored locally or remotely) for ballistics data associated with a particular cartridge and bullet. If a desired cartridge/bullet is found, the user may select 606 it for use by the MBPDS in ballistics processing (rather than manually inputting such ballistics information). Alternatively, users may skip this step 606 and proceed to the “Input Bullet Data” step 608, which prompts users to manually input information relating to the particular cartridge/bullet that he or she will be using. In one embodiment, users will be prompted to manually input the bullet caliber 610, bullet weight 612, bullet muzzle velocity 614, bullet ballistic coefficient 616, and the bullet drag model 618.

Still referring to FIG. 6, users of the MBPDS are next provided with an “Input Rifle Data” step 620, which prompts them to manually input rifle setup information that is used in processing ballistics solutions. In one embodiment, users are prompted to manually input information relating to sight height (distance between axis of bore and axis of optical sight) 622, zero range (range at which rifle was zeroed) 624, elevation offset (elevation distance by which optical sight if off zero) 626, and windage offset (windage distance by which optical sight if off zero) 628. In one embodiment of the MBPDS, the input (either manually or from a database such as the bullet library) of load data and rifle data is required before the processing of a ballistics solution by the MBPDS. In one embodiment, users are provided with the option to input spin drift 630 information for further accuracy in ballistics processing. If users choose to enter spin drift information, they are prompted to manually input bullet length 632 and spin twist 634.

In one embodiment of the MBPDS, users are provided with the option to display graphical representations of in-flight bullet characteristics, which provide users with an easily understandable illustration of how a particular bullet's in-flight characteristics will change along a projected path from the shooter to a target. As explained in further detail below with reference to FIG. 9 and FIG. 10, the graphical representation of in-flight bullet characteristics may be illustrated, in one embodiment, by an overlay over the map display, allowing a user to understand projected in-flight characteristics in the context of the actual shooting environment. A GBCO (“Graphical Bullet Characteristics Overlay”) step 636 is provided, allowing a user to provide in-flight bullet/projectile characteristic criteria to be used in generating the graphic representations of the in-flight bullet characteristics. In one embodiment, a user may a desired maximum vital range value (“MVR”) 638, which is the maximum distance at which a bullet will strike a particular vital area (length in units chosen by user) without the need for making elevation adjustments. Another in-flight bullet characteristic criteria that users may manually input is the energy threshold (“Et”) 640, which is the minimum energy (ft/lbs) that a shooter would desire to deliver to a target. Another in-flight bullet characteristic criteria that users may manually input is the velocity threshold (“Vt”) 642, which is the minimum velocity (ft/s) that a shooter would desire to deliver to a target. It should be noted that in alternate embodiments of the MBPDS, any in-flight bullet characteristic or criteria may be utilized in displaying the types of graphical representations claimed herein.

In alternate embodiments of the MBPDS, the MBPDS may be configured to automatically calculate line of sight angle. For example, in such alternate embodiments of the MBPDS, a line of sight angle could be calculated for an uphill or downhill shot if the distance to target were ascertained (via laser rangefinder, mil-dot optic, map data, or human estimate), and the elevation of the shooter and target were ascertained (via map data or GPS data).

In alternate embodiments of the MBPDS, the system will be capable of receiving the user input of additional accuracy enhancing information through real world ballistics data collection (also referring to as a “trueing” process). While published ballistics information for a particular projectile will be accurate to some degree, actual real world ballistics behavior can deviate from published results that might otherwise be used in ballistics processing. Accordingly, users may find that a particular projectile, in this scenario a bullet, exhibits in-flight characteristics different than that which has been published. The MBPDS may be configured, in alternate embodiments, to receive the input of a user, of such real world ballistics data associated with predetermined shot distances. The MBPDS will be capable of processing such ballistics data to modify the ballistics data used in ballistics processing, thereby increasing the accuracy of the processing results.

Referring now to FIG. 7, a process flow diagram associated the “Weather” icon 516 included in a software application executed by an embodiment of the MBPDS. User are initially provided with the option to manually input information associated with one or more local weather attributes for use in processing ballistics solutions. More specifically, users may manually input wind data and even more specifically, the wind speed 704 and the wind direction 706. In alternate embodiments of the MBPDS, users will be permitted to input differing wind data at one or more points or sections of a bullet's projected path.

Still referring to FIG. 7, users next have the option of manually inputting other information relating to atmospheric 708 conditions such as atmospheric pressure 710, air temperature 712, relative humidity 714, and altitude 716. In one embodiment, users are further provided with the option to acquire atmospheric data from an online 718 source for such data (for example, the weather server described with reference to FIG. 3). As it is important for the processing of ballistics solutions that weather data not be stale, users are prompted to reload 720 weather data prior to initiating ballistics processing. In one embodiment of the MBPDS, users will be provided with the ability to choose 722 from one or more commercially or privately available online sources of weather data. Atmospheric/weather data that may be acquired from an online source may include, but is not limited to, data associated with wind speed/direction 724, atmospheric pressure 726, and relative humidity 728. The user will be provided with the weather/atmospheric data from the online source and, if the data appears to accurately reflect the actual local weather conditions, the user will be prompted to select the data for use 730.

Referring now to FIG. 8, a block diagram menu map associated with the “Extended Menu” icon 524 included in a software application executed by an embodiment of the MBPDS. The “Extended Menu” icon 524 may be selected by a user from the main menu 500, allowing the user to access various sub-menus of the software. A “Mode” sub-menu is provided to users, allowing a user to choose the manner in which he or she wants the results of ballistics processing to be displayed. The user may select a “Map” icon 804 to display ballistics solution information on a map as further described below with reference to FIG. 9. Alternatively, the user may select a “Chart” icon 806 to display ballistics solution information in chart/table format as further described below with reference to FIG. 11. In chart mode, the user will be permitted to select the maximum range 808 and distance increments 810 to be display in the ballistics chart/table.

A “Solution Data Display” icon 812 is further provided to users, allowing them to set the type of units that the MBPDS will display in connection with calculated ballistics solutions. In one embodiment, users may select range and holdover units of inches or centimeters, milliradians (“Mil”), or minutes of angle (“MOA”). A “GBCO” icon 820 (“Graphical Ballistics Characteristics Overlay”) is further provided to users, allowing users to activate or deactivate (on/off) the GBCO in map mode. A “Save Range Card” icon is provided to users, allowing a previously created range card (map and ballistics data) to be named and saved 830. A “Load Range Card” icon is further provided to users, allowing a user to access a previously saved range card to be selected 830 and loaded for further use by the MBPDS. A “Delete All Pins” icon 832 is provided, allowing a user to delete all pins displayed on a map when the MBPDS is in map mode. A “Search Location” icon 834 is provided, allowing a user to input geographic information (city, state, zip, etc.) 836 to access maps at the specified location. A “Help” icon 838 is further provided, providing users with a link 840 to an online help manual associated with the MBPDS. A “Targeting” icon 842 provides users, as discussed in further detail below, with the ability to display a real-time targeting solution on the mobile computing device when said device is mounted to an optical sight.

Referring now to FIG. 9, a screenshot 900 of a display of an embodiment of the MBPDS, said display showing geographic information, ballistics solutions, representations of approximate in-flight bullet characteristics (GBCO), and menu options available to a user as also shown at FIG. 4. A satellite view of a map 902 is shown on the display (map views may be toggled by user by selecting the map icon 903). In one embodiment, the display shows the caliber 904 of the bullet for which the ballistic solution has been processed. A shooter icon 906 indicates the location of the shooter on the map, and one or more target icons 908 show the locations of one or more targets on the map. A solid line 910 is displayed between the shooter icon and at least part of the distance along the projected bullet path to the one or more targets. As described further below with reference to FIG. 10, the MBPDS in one embodiment utilizes a solid line to graphically represent that portion of the bullet's path to the target in which it is considered to have ideal characteristics (within maximum vital range, and having traveled a distance less than Et and Vt). Ballistics solutions information is displayed adjacent to the target icon, although in alternate embodiments, it may be displayed elsewhere on the display. In one embodiment of the MBPDS, the distance between the target and the shooter 912, elevation adjustment 914, and windage adjustment 916 are displayed on the map.

In one embodiment, further graphical representations are displayed on the map, indicating the projected bullet characteristics (as compared to the user-inputted criteria) along the bullet's path from the shooter to a target. The display screen of the MBPDS, communicatively connected to the MBPDS central processor unit, is configured to depict a projected path of said bullet/projectile on a map corresponding to a position of said system, said projected path being displayed on said map using one or more differing types of graphical representations, said one or more differing types of graphical representations being selectively displayed based on a comparison of said projected in-flight characteristics for the bullet/projectile and said one or more in-flight projectile characteristics criteria.

For example, in one embodiment of the MBPDS, the projected bullet path is represented by circles 918 at distances greater than the user-inputted maximum vital range, but still less than the velocity threshold (Vt) and energy threshold (Et). At distances greater than the velocity threshold but less than the energy threshold, the bullet path is represented as a cross or “plus” sign 922. At distances greater than the maximum vital range, velocity threshold, and energy threshold, the bullet path is represented by diamonds 924. It should be noted that colors and shapes chosen to describe the embodiments of the GBCO (Graphical Bullet Characteristic Overlay) utilized by an embodiment of the MBPDS are merely exemplary. It is contemplated that in alternate embodiments of the MBPDS, the graphical representations used in connection with the GBCO may be represented by any number of differing shapes and/or colors.

Referring now to FIG. 10, further illustrating an embodiment of graphical representations 1000 of approximate in-flight bullet characteristics as displayed 1002 by an embodiment of the MBPDS as also shown at FIG. 9. A shooter icon 1006 indicates the location of a shooter. A solid line 1008 is displayed between the shooter icon and at least part of the distance along the projected bullet path to the one or more targets. Along that portion of the bullet path (which could be the entire bullet path) that is represented by a solid line, the bullet characteristics are considered ideal to the user, meaning that the bullet meets all specified criteria. In the embodiment described herein, ideal bullet characteristics occur when the distance between the shooter and the bullet is less than the maximum vital range, velocity threshold, and energy threshold. The projected bullet path is represented by solid black circles 1010 at distances greater than the user-inputted maximum vital range, but still less than the velocity threshold (Vt) and energy threshold (Et). At distances greater than the velocity threshold but less than the energy threshold, the bullet path is represented as an unshaded circle or as a circle having a non-black color 1012. At distances greater than the maximum vital range, velocity threshold, and energy threshold, the bullet path is represented by circles having alternating colors or alternating between shaded and unshaded circles 1014. As noted above, it is contemplated that in alternate embodiments of the MBPDS, the graphical representations used in connection with the GBCO may be represented by any number of shapes and/or colors.

Referring now to FIG. 11, a screenshot of a display of an alternate embodiment of the MBPDS, said display 1100 showing graphical representations of boundaries around a target, projecting geographic areas where a projectile will meet, exceed and/or fall below defined in-flight projectile characteristics criteria based on ballistics processing by said MBPDS. Based on the ballistics variables of the projectile and other variables such as atmospheric conditions, the MBPDS will be capable of generating data associated with projected in-flight characteristics corresponding to said projectile. Moreover, as previously described above, the MBPDS is configured to receive data associated with one or more in-flight projectile characteristics criteria such as, for example, maximum vital range (MVR), velocity threshold (Vt), and energy threshold (Et). With such information, the MBPDS will be capable of calculating the distances from a particular target, that a projectile will have in-flight projectile characteristics that meet, exceed, and fall below such in-flight projectile characteristics criteria. Utilizing such information, the MBPDS in alternate embodiments, can utilize graphical representations to display locations on an electronic map, where a user may take a shot at a target from to meet such criteria.

Still referring to FIG. 11, the MBPDS is configured to display a map 1102 showing the position of the shooter 1104 and the position of one or more targets 1106 in relation to terrain features and other map features (trees, streams, ponds, streets, buildings, etc.). Using an alternate embodiment of the GBCO, differing graphical representations can be used to indicate areas on the map where the user could take a shot at the target such that his or her bullet would be within certain in-flight characteristics criteria. For example, a particular projectile under particular atmospheric conditions, a circle represented by a solid line may illustrate the area around the target at which the projectile, just at the point-of-impact at the target 1106, would be within MVR, Vt, and Et (“ideal conditions”). Thus, the GBCO would therefore indicate to the user that should a shot be taken outside of the circle 1108, the target is beyond the maximum vital range. The boundaries at which other in-flight projectile characteristics criteria would be met, exceeded, or fall below may be represented by other graphical representations. For example, a dotted line may be used to represent a circular boundary 1112 around the target, defining locations beyond which a shot at the target would result in a projectile having a velocity (at point-of-impact) less than the velocity threshold (Vt) 1114. Similarly, an alternating dashed and dotted line may be used to represent a circular boundary 1116 around the target, defining locations beyond which a shot at the target would result in a projectile having energy (at point-of-impact) less than the energy threshold (Et) 1118. It should be noted that the boundaries corresponding to in-flight characteristics criteria shown in FIG. 11 have been represented as circular for ease of explanation. However, depending on the ballistics variables (including projectile characteristics and atmospheric conditions), the boundaries may not appear circular under actual conditions.

In even further alternate embodiments, the GBCO may be represented using differing colors. For example, a multi-colored heat map, indicating the approximate in-flight bullet characteristics of a bullet at each point on the map display. For example, in one alternate embodiment, an area around a target (corresponding to a ballistics solution) representing shooting locations associated with ideal bullet characteristics, may be indicated by a shaded green color. A separate color shaded around the same target may be used to represent all distances from the target that are greater than the maximum vital range, but less than the velocity threshold and energy threshold. In this manner, an intuitive graphical representation is provided to the user, showing on a map the points to which he or she must be located to take a shot at a target in order for the bullet to have certain in-flight characteristics in the general manner described above with reference to FIG. 11.

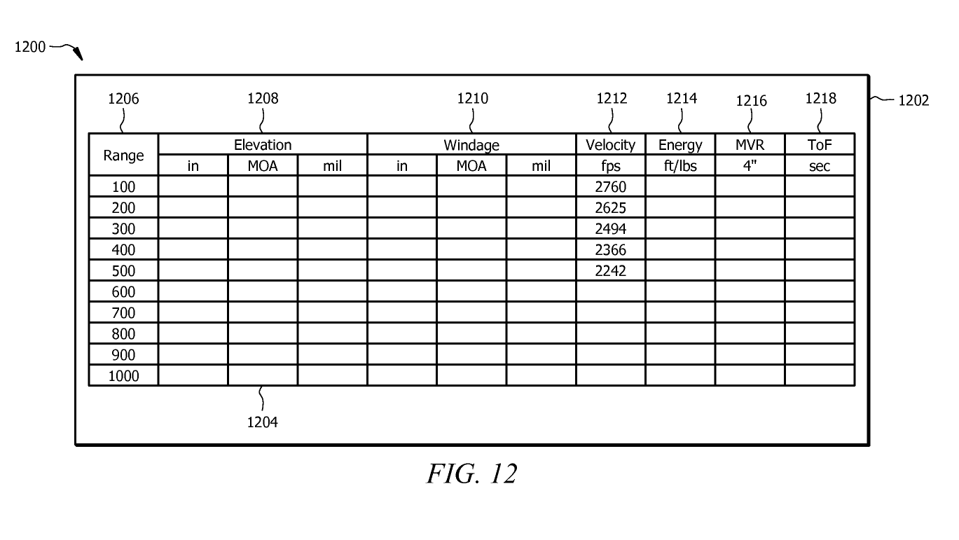

Referring now to FIG. 12, a screenshot 1200 of a display of an embodiment of the MBPDS, said display 1202 showing a ballistics table 1204 on which data resulting from ballistics solution processing is displayed. In chart mode, the MBPDS is configured to display ballistics information in incremental distances (range 1206) from the shooter's location to the target. For example, in one embodiment, a column 1212 of the ballistics table indicates the calculated velocity (in units of feet per second) of a bullet in one hundred yard increments from one hundred yards to five hundred yards. Other such information appearing on the ballistics information may include elevation adjustments (in units of inches, MOA, and mil) 1208, windage adjustments (in units of inches, MOA, and mil) 1210, energy (in units of ft/lbs), maximum vital range (in units of inches), and bullet time of flight (ToF) (in units of seconds). It is contemplated that in alternate embodiments of the MBPDS, the ballistics table may display all manner of ballistics and other data that may be useful to a shooter.

Referring now to FIG. 13, a block diagram illustrating exemplary components of a further embodiment of the mobile ballistics processing and display system as embodied in a mobile computer processing device 1300. In one embodiment, the mobile computer processing device 1300 can include system storage, memory interface, central processor unit(s), input/output (“I/O”) and peripheral devices interface. Sensors, devices, and subsystems can be coupled to an I/O and peripheral device interface 1302 to facilitate multiple functionalities. For example, one or more cameras 1307, accelerometers 1304, a display(s) 1306, global positioning system (“GPS”) transceiver 1308, communications subsystem 1310, and audio subsystem 1312 can be connected to I/O and peripheral devices interface 1302 to aid in driving various functions of the device 1300.

For example, in some embodiments, the GPS transceiver 1308 may be utilized to locate the position of the mobile computer processing device, and identify positional data associated with one or more target locations. From such information, target ranging information may be derived. Further, in some embodiments, one or more accelerometers 1304 integrated into the computer processing device may be utilized to detect the orientation of the device, allowing for the processing of a more precise ballistics and targeting solution. As discussed further below, one or more accelerometers may also be utilized to collect initiate the collection of positional data associated with the point of impact just prior to and at the time of firearm discharge. In one embodiment of the mobile computer processing device, one or more cameras may be utilized to provide images of an optical sight picture, and to record said optical sight picture before, during and/or after a shot is made.

In one embodiment, a display 1306 implemented in the mobile computer processing device may be utilized to facilitate the display of, among other items, a graphical user interface (or “data interface”) for inputting firearm and projectile parameters, communicating with an MBPDS server, inputting and receiving atmospheric/weather data, acquiring, inputting and displaying positional data, and inputting and displaying targeting information and solutions. In one embodiment, the display 1306 may utilize various technologies such as LCD, Oxide LCD, a-Si, and TFT LCD display technologies to depict text and other information graphics in a high resolution rendering.

Functions related to communications can be facilitated through one or more communication subsystems 1310 that can include one or more wireless or wired communication subsystems. Wireless communication subsystems can include radio frequency receivers and transmitters 1311, and/or optical (e.g., infrared) receivers and transmitters. Wired communication systems can include a port device, e.g., a Universal Serial Bus (USB) port or some other wired port connection that can be used to establish a wired connection to other computing devices. In one embodiment of the mobile computer processing device 1300 embodying aspects of the MBPDS, an audio subsystem 1312 can be coupled to a speaker 1313 and one or more microphones 1314 to provide voice-enabled functions, such as voice recognition, voice replication, digital recording, and telephony functions. For example, in one embodiment, a microphone may be utilized to facilitate voice-activation by the user of the recording functionality of the device such that the initiation of a recording may be triggered by a user command received by the microphone and analyzed/recognized by the processor such that it is not necessary for the user to take his or her eyes off of the display to initiate such a recording.

Input/control devices 1316 can include a touch controller and a touch surface 1318, and/or other input controller(s) such as a keyboard and/or mouse 1320. The touch controller can be coupled to the touch surface for directing and processing signals from the touch surface to the processor. A touch surface and touch controller 1318 can, for example, detect contact and movement using any of a number of touch sensitivity technologies, including but not limited to capacitive and resistive technologies, as well as other proximity sensor arrays or other elements for ascertaining one or more points of contact with the touch surface. In one implementation, a touch surface can display a virtual keyboard 1320, which can be used as an input/output device by the user. Other input controller(s) can be coupled to other input/control devices, such as one or more buttons, rocker switches, thumb-wheel, infrared port, USB port, and/or a pointer device such as a stylus (not shown).

In embodiments of the mobile computer processing device of the MBPDS, a memory interface 1322 can be coupled to system storage 1324 and central processor unit(s) 1326. System storage 1324 may include volatile high-speed random access memory 1328 or non-volatile memory 1330. In one embodiment of the mobile computer processing device, the system storage may include storage media technologies such as RAM, ROM, EEPROM, flash memory or other memory technology, digital versatile disks (DVD) or other optical storage, magnetic disk storage, or any other medium which can be used to store desired information and which can be accessed by the device.

The storage system may also store instructions to facilitate the operation of the mobile computer processing device, and communications with one or more additional computing devices, such as one or more computing devices comprising embodiments of the MBPDS, and computers or servers facilitating one or more functional aspects of the MBPDS. Operating system instructions 1332 for the computer processing device may be stored in the storage system. Operating system software such as iOS, Android, Darwin, RTXC, LINUX, UNIX, OS X, or WINDOWS may be used to facilitate operation of the device. For example, operating system instructions may include instructions for handling basic system services and for performing hardware dependent tasks. One or more central processor units 1326 are connected to the memory interface 1322, which is in turn connected to the storage system. Such processor(s) may run or execute the operating system and various other software programs and/or sets of instructions stored in memory to perform various functions for the mobile computer processing device.

The storage system may include graphical user interface instructions 1334 to facilitate graphic user interface processing, such as generating the GUIs shown in FIGS. 4, 9, 11, 17, 18 and 19; web browsing instructions 136 to facilitate web browsing-related processes and functions and display GUIs described in reference to FIGS. 4, 9, 11, 17, 18 and 19; communications instructions 1340 for facilitating communications to and from the device; and instructions for an MBPDS device application 1338 that is capable of displaying GUIs, as described in reference to FIGS. 4, 9, 11, 17, 18 and 19, and providing other functionality of the MBPDS as described herein. The storage system memory may also store other software instructions for facilitating other processes, features and applications, such as applications related to navigation, post-shot processing, social networking, location-based services or map displays.

In an embodiment of the MBPDS, the storage system of the mobile computer processing device may include one or more storage databases 1332 stored preferably in non-volatile memory. Such databases may store information such as software, data associated with ballistics processing, user account information associated with a user account created in conjunction with a provider of information associated with ballistics processing (MBPDS server, GIS server, weather server, etc.), other user information, drivers, and/or any other data item utilized by the computer processing device and servers taught herein.

In one embodiment, the mobile computer processing device of the MBPDS further includes a power control unit and one or more batteries 1344. The power control unit 1344 is configured to control the amount of power consumed by the device. Those of skill in the art will recognize that by actively controlling the amount of power consumed by the device, the device may achieve more efficient use of electrical energy that is consumed by the device. The power control unit may include a clock and/or timer for precise control of power consumed by the MBPDS. The power control unit may include any combination of hardware and software, and digital and/or analog circuitry. The power control unit (also may be referred to or further include a battery management unit) may include one or more microcontrollers and/or other hardware modules. Embodiments of the device may include one or more rechargeable batteries or other battery system for powering the device, including one or more batteries coupled together in parallel or series configuration to output any desired voltage and/or current. One or more batteries may be implemented by utilizing rechargeable battery chemistry including, but not limited to, nickel metal hydride (NiMH), lithium polymer, and lithium ion battery chemistries. In other embodiments of the device, the mobile computer processing device may be supplied power via a wired power connection.

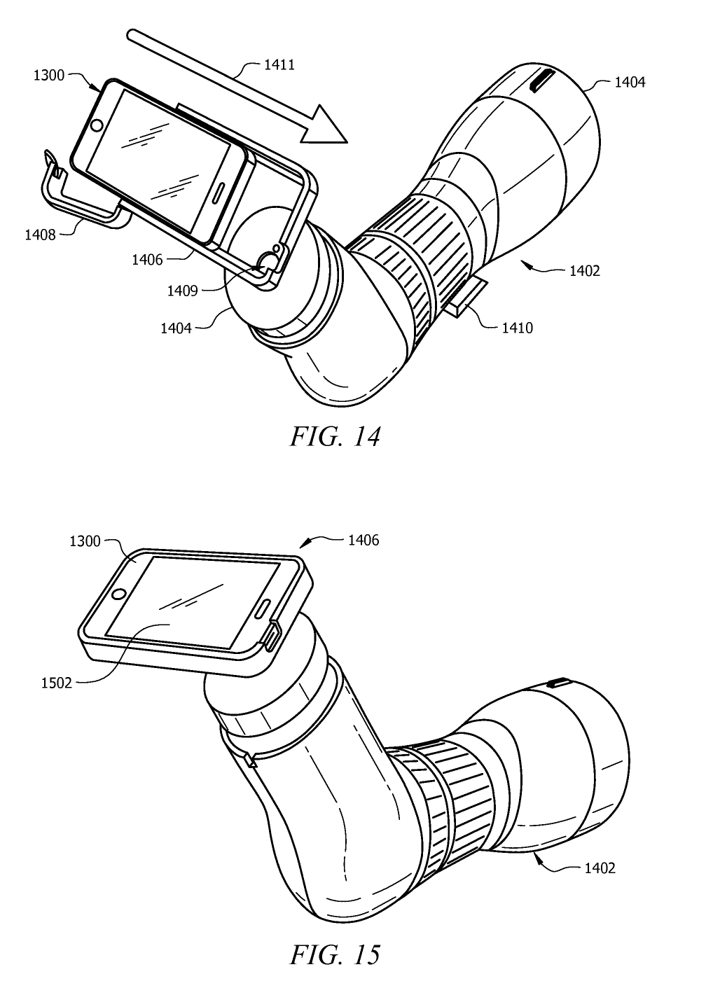

Referring now to FIG. 14, an illustration of a perspective view of an embodiment of a mobile computer processing device on which exemplary processes of an embodiment of the mobile ballistics processing and display system may be executed, said mobile computer processing device 1300 being mounted to an optical spotting scope 1402. It should be noted that although the sights discussed herein for the purpose of describing exemplary embodiments of the MBPDS are made with reference to optical sights such as spotting scopes and rifle scopes, it is fully contemplated that alternate embodiments of the MBPDS may be mountable or otherwise coupled to other viewing instruments, optical and non-optical sights such as, by way of example, rangefinders, binoculars, telescopes, thermal imaging devices, night vision devices and cameras, all of which may or may not be configured for mounting into a firearm.

In one embodiment, the mobile computer processing device 1300 is removably physically mounted/coupled to a spotting scope 1402 having an objective lens 1404 and an eyepiece 1404 connected by a scope body. The mobile computer processing device 1300 is mounted to the scope via a mounting adapter 1406 having a receptacle sized to receive a correspondingly sized mobile computer processing device 1300. In the embodiment shown in FIG. 14, the receptacle of the mounting adapter includes two channels in which the mobile computer processing device is configured to slide 1411 such that when fully secured, a camera lens (or other image sensing device) on said device is aligned with an aperture positioned on the adapter, which is in turn mounted on or integral to the scope eyepiece or other scope structure, such that transmission of light from the objective lens of the scope may be transmitted to said camera found on the mobile computer processing device. A hinged latch 1408 on the mounting adapter, sized to correspond to the dimensions of the mobile computer processing device 1300, is utilized to secure and stabilize the device with respect to the scope. It should be noted that all manner of various embodiments of the mounting adapter may be utilized with respect to alternate embodiments of the MBPDS. By way of example, in alternate embodiments of the MBPDS, a mounting adapter or the MBPDS computing device itself (without the need for a mounting adapter) may be mounted to structures of the optical sight other than the eyepiece such as, structures 1410 for mounting the sight to other objects (firearms, stabilizing rods, vehicles, and other static or mobile platforms).

In even further embodiments of the MBPDS, the computer processing device may be secured to accessories worn or otherwise attached to a user. For example, the computer processing device of the MBPDS may be removably mounted to a head strap, head mount, or helmet mount in a manner allowing the user to view the display of the device. Such head strap, head mount, or helmet mount may allow the device to pivot, rotate, extend and/or otherwise move to allow the user may manipulate the position of the device with respect to himself or herself, as well as move independently with respect to a scope or other sighting device. An advantage of such an alternate embodiment for mounting is that it would not be necessary for the mobile computer processing device to be secured to the sighting device when not in use. In such an alternate embodiment, various fasteners and other mechanisms may provide the user with the ability to temporarily secure the mobile computer processing device to the optical sight. In one embodiment, magnets placed on the computer processing device, a device casing, the mounting adapter, and/or optical sight may be utilized to temporarily secure and stabilize the device to the optical sight, but allowing for easy removal from the sight when desired. In even further embodiments, a camera or other imaging sensor may be mounted to or be integral to the optical sight, and configured to wirelessly transmit imaging data to a remote processing device for viewing by a user. In such an embodiment, an optical head-mounted display (for example, Google Glass provided by Google Inc.) may be configured to receive wireless imaging data from a camera or other imaging sensor mounted to or integral to an optical sight such that the mobile computer processing device of the MBPDS may include two or more physically separate but electronically coupled (wired or wireless) components.

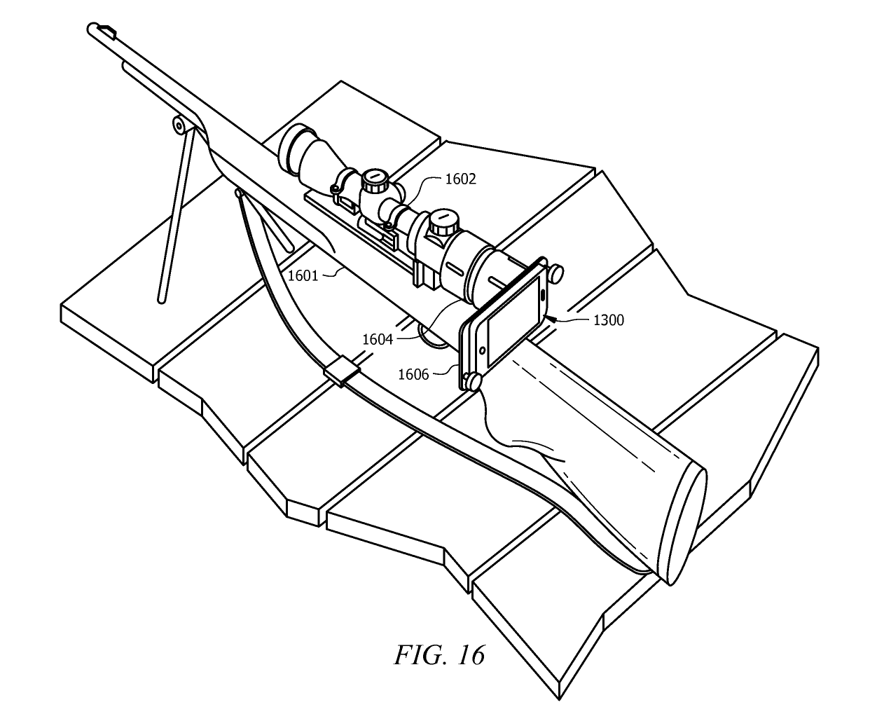

Referring now to FIG. 15, which illustrates a perspective view of the embodiment of the mobile computing device 1300 and spotting scope 1402 shown in FIG. 14, said mobile computing device mounted on said spotting scope via one embodiment of a mounting adapter 1406. Once secured to the scope, a display 1502 of the mobile computer processing device 1300 is positioned and oriented to face outward such that a user may easily view a graphical user interface on such display, which provides for an enhanced visualization of the sight picture of the scope and targeting solutions as discussed in more detail below. It is contemplated that users of the MBPDS may utilize the mobile computing device to visualize targeting solutions with the aid of a spotting scope when alone or alternatively, when working with one or more other persons as a team. For example, when working as a team, a first team member may utilize the computer processing device mounted to a spotting scope to visualize one or more targeting solutions, and communicate information about the targeting solution(s) to a second team member operating a firearm. Such communication between team members pertaining to targeting information may occur via voice or alternatively, via a wired or wireless communication system. When used by one user, such a user may use the computer processing device mounted to a spotting scope to visualize targeting information, and then utilize such targeting information in making a shot with a firearm having a separate optical sight.

Referring now to FIG. 16, a perspective view of an embodiment of a mobile computer processing device on which exemplary processes of an embodiment of the mobile ballistics processing and display system can be executed, said mobile computer processing device 1300 being mounted adjacent to the eyepiece 1606 of a rifle scope 1602. In one embodiment of the MBPDS, the mobile computer processing device 1300 is mounted directly to a rifle scope 1602 or alternatively, to a mounting adapter 1606 which is in turn mounted to a rifle scope 1602. In one embodiment of the MBPDS, the mobile computer processing device is mounted to a rifle scope having a reticle or other aiming feature for assisting users of a rifle (or other firearm) in achieving accurate shot placement. In one embodiment, the rifle scope includes a reticle positioned within the second focal plane of the scope such that the appearance (size of reticle in relation to sight picture) of the reticle does not change, with respect to the user of the scope, when the magnification of the scope is varied by a user. While those of ordinary skill in the art will recognize that modifications to the present invention may be made so as to utilize the MBPDS in conjunction with a rifle scope having a reticle positioned within the first focal place or other location within the scope (or a reticle displayed on a non-optical sighting device), the embodiments of the MBPDS are taught herein with reference to use with a rifle scope having a reticle positioned within the second focal plane of the scope.

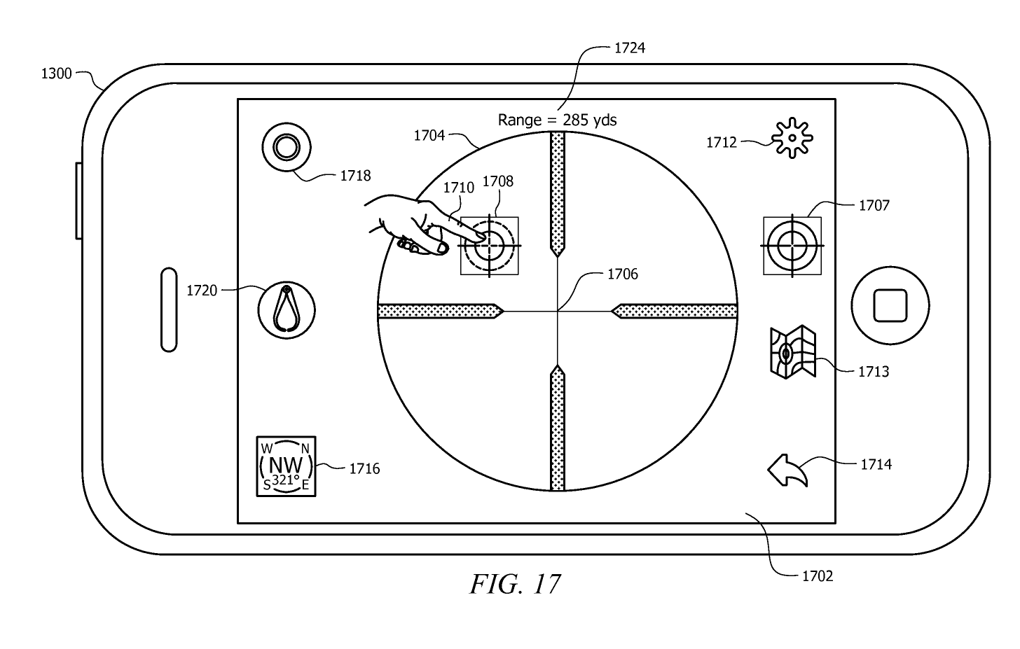

Referring now to FIG. 17, illustrating a screenshot of a display of an alternate embodiment of the mobile computer processing device of the mobile ballistics processing and display system as mounted on an optical sight, said display showing a reticle of the optic sight, and other graphical representations configured for facilitating the calibration of the system. Once mounted on a rifle scope (or other optical sighting tool) such that the camera of the mobile computer processing device is oriented to view light transmitted through the scope, an image of the scope reticle 1706 is presented on the display 1702 of the device 1300. In addition to the reticle, the display further presents all or a portion of the sight picture 1704 viewable through the scope. Used in conjunction with the other functionality of the MBPDS as described herein, the computer processing device of the MBPDS provides users with the ability to visualize targeting solutions with visual reference to the sight picture of the optical scope, said targeting solutions being calculated by using the ballistics processing capabilities as described herein.

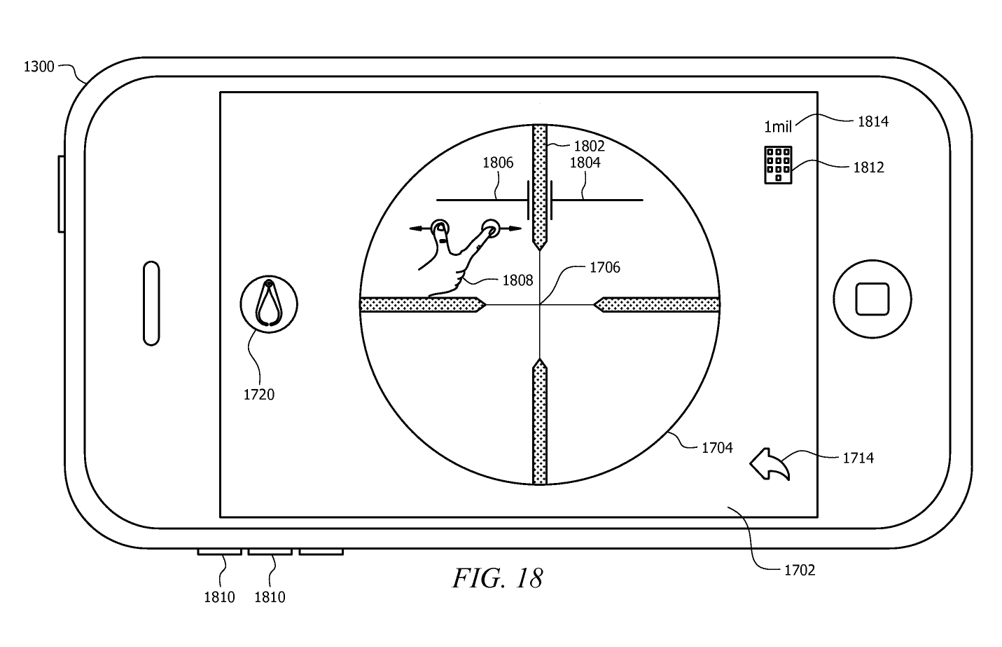

In one embodiment of the MBPDS, the display of the mobile computer processing device provides information to the user concerning data associated with a particular shot configuration. Information inputted or otherwise acquired by the MBPDS, as well as data associated with the results of ballistics processing, is fully communicable to aspects of the MBPDS associated with the processing and display of targeting information as discussed below. For example, by utilizing the geographical positioning data obtainable through the MBPDS (as discussed above), a distance (or “range”) between the shooter location and the target is acquired and displayed 1724. A map icon 1713 may be displayed to the user so as to allow the user to select such icon (utilizing touch screen interface) to navigate the MBPDS software application to access features associated with geographical positioning information as discussed above. Other information utilized by the MBPDS and displayed to the user may include the compass orientation (compass heading) 1716, which is derived from data collected by one or more accelerometer(s) used in conjunction with one or more magnetometer(s) integrated into the mobile computer processing device. Other icons that may optionally be displayed and selected by a user include a recording icon 1718, which may be selected by a user to start, pause and stop the recording of images shown in the sight picture 1704. A calibration icon 1720 may be selected, as discussed further with reference to FIG. 18, to calibrate the coordinate system of the display with respect to the particular scope on which the mobile computer processing device is mounted. A settings icon 1712 is displayed and may be selected to allow the user to access controls for making changes to various user-controllable variables of the computer processing device (for example, brightness of display). An arrow icon 1714 is displayed and is selectable by a user to navigate to other menu and sub-menu screen(s) of the MBPDS software application.

In one embodiment, a virtual reticle icon 1707 is shown on the display of the mobile computer processing device, and may be selected by a user to initiate a first step in calibrating the device with respect to the scope to which the device is mounted. As the sight picture 1704 shown on the display of the device may not be precisely aligned with the sight picture viewable through the scope (as transmitted through the camera of the device), it is preferable that the coordinate system of the display be associated with the center of the sight picture of the optical sight and even more preferably, the intersection of the crosshairs of the scope (the zero position of the optical sight). Ideally, prior to calibration, the rifle scope will be zeroed at a particular range for a particular projectile/rifle as discussed above. It should be noted that an x-y axis grid system may be utilized in conjunction with the display of the mobile computer processing device and even more particularly, to that portion of the display constituting the sight picture 1704. In this manner, a two-dimensional coordinate system may be implemented such that the MBPDS may accurately show point of impact data on the display in an accurate manner.

Still referring to FIG. 17, in order to calibrate the coordinate system of the display in relation to the intersection of the crosshairs of the scope reticle, a user may select the virtual reticle icon 1707, which causes a virtual reticle 1708 to appear within the sight picture of the display. Using a finger 1710 on the touch surface of the display, a user may manually slide the virtual reticle 1708 such that the center of the virtual reticle is aligned with the intersection of the crosshairs of the reticle of the scope 1706. Once aligned, the user may select the virtual reticle icon 1707 to confirm that the position of the virtual reticle is aligned with the reticle of the scope. In other embodiments of the MBPDS, image recognition functionality may be utilized to automatically recognize the intersection of the crosshairs of the scope reticle, and to assign the location of such intersection as the “center” or “zero” of the display's coordinate system.

Referring now to FIG. 18, which illustrates a screenshot of a display of the alternate embodiment of the mobile computer processing device of the mobile ballistics processing and targeting display system as mounted on an optical sight as shown in FIG. 16, said display showing a reticle of the optical sight, and other graphical representations configured for facilitating the calibration of the system. With respect to optical sights in which a reticle is positioned within the second focal plane, many such reticles include marking features (“subtensions”) to aid shooters in achieving accurate shot placement. Such subtensions also provide users with the ability to estimate both the range of targets and the dimensions of objects within the sight picture. The dimensions (typically height or width) of subtensions are generally ascertainable through published manufacturer specifications associated with a particular scope which displays such subtensions. When such subtensions form part of a reticle found in the second focal plane of a scope, the dimensions of such subtensions are typically only ascertainable (without special tools) to a user at the highest available magnification of a variable power scope.

In one embodiment of the MBPDS, the coordinate system of that portion of the display providing the sight picture of the scope, may be manually or automatically calibrated with two-dimensional distance information for a particular range viewable through the scope. In this manner, the coordinate system of the display will equate to actual distances of objects viewed through the scope (and the display of the mobile computer processing device), which is essential to displaying accurate targeting solutions to the user on the display. By depressing the calibration icon 1720 on the display, the user may initiate the second step of the calibration process.

Still referring to FIG. 18, a user may utilize the touch screen of the display to manually manipulate virtual calipers to acquire the position of (or measure in terms of units of the coordinate display) subtension dimensional attributes of the scope reticle. In this manner, the dimensional attributes of a subtension, from which actual distances at the target location can be calculated, can be used to further calibrate the units of the coordinate system of the display (for example, pixels). Although the subtension shown in FIG. 18 refers to the width of a duplex of a vertical reticle post, it is contemplated that other subtension marking features may also be utilized in other embodiments (for example, milliradian markings). More specifically, a user may utilize two fingers to roughly adjust the width of the virtual calipers such that a left portion of said calipers abuts a left edge of a subtension and a right portion of said calipers abuts a right edge of said subtension. Fine adjustments to the virtual calipers may be accomplished by depressing buttons 1810 located on the computer processing device (for example, smartphone volume buttons) configured to receive such user input. Once the user has aligned the calipers with the outer edges of the subtension marking feature, the MBPDS application will store the horizontal axis positions of the inner edges of the vertical posts of the calipers. In one scenario for exemplary purposes, the width of the subtension may correspond to ten pixels on the horizontal axis of the coordinate system of the display.

The user may then select the keypad icon 1812 to enter the known subtension dimension (ascertainable from scope specifications). In one scenario for exemplary purposes, the width of the subtension may correspond to one milliradian or one “mil.” In alternate embodiments, the inputting of subtension dimensions may occur prior to calibration. For example, subtension dimensions may be preloaded by the user into the MBPDS, or downloaded from the MBPDS server.

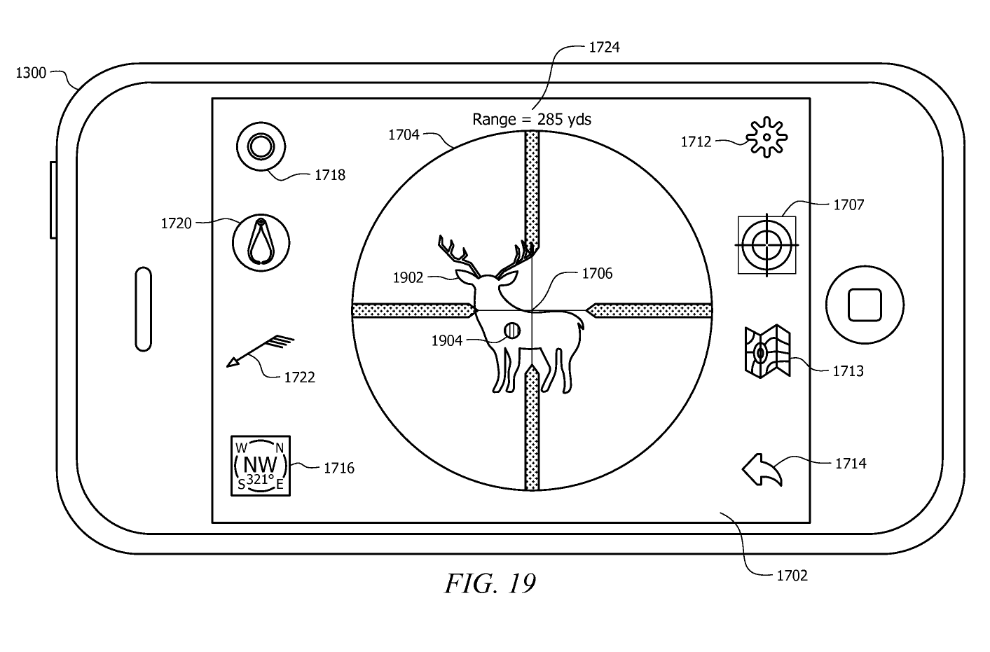

By utilizing trigonometric principles, the MBPDS is capable of calculating, for a known range to the target location, a distance at the target location as it equates to the subtension dimensions (in this scenario, the width of the duplex). For example, if the width of the subtension is known to be one milliradian, the distance to which the subtension equates at one thousand yards is approximately thirty-six inches. Accordingly, when calibrated according to the steps set forth herein, the coordinate system of the display of the mobile computer processing device will associate ten pixel units of the horizontal and vertical axis of the coordinate system with thirty-six inches at the target location. Using such principles, any positional distance at the target location may be translated into positional distances on the coordinate system of the display. Once manual calibration of the coordinate system of the display is completed, the user may select the arrow icon 1714 to return to the main targeting display as shown in FIG. 17 and FIG. 19.

In other alternate embodiments, image recognition principles may be employed to calibrate the coordinate system of the display with respect to positional information at the target location. For example, in one embodiment, such automatic calibration may be accomplished through the use of image recognition technology. More specifically, image recognition technology may be utilized recognize and measure the position of subtension(s) appearing on the display, and automatically associated such positions (and the distance between such positions) with the known dimension of the subtension(s). From this information, units of the coordinate system of the display can be translated into distances at the target location, and vice-versa.

Referring now to FIG. 19, which illustrates a screenshot of a display of the alternate embodiment of the mobile computer processing device of the mobile ballistics processing and display system as mounted on an optical sight as shown in FIG. 16, said display showing a graphical representation of the point of impact according to a targeting solution processed by the system, said point of impact displayed adjacent to a display of a reticle of the optical sight. Prior to the display of targeting information on the display, a user will preferably calibrate the display with reference to the optical sight for a particular range to target as discussed above. The range of the target, as well as other data associated with ballistics processing, may be inputted, acquired or otherwise calculated using the systems and processes of the MBPDS discussed herein. This information may be utilized by the MBPDS to display a targeting solution to the user.

For example, a ballistics solution may be processed by taking into account rifle and projectile parameters, atmospheric data (for example, wind speed and direction, which may be displayed to the user via a wind icon 1722), the heading of the rifle (shown with the compass icon 1716), positional data (from which range data may be calculated and displayed 1724), and orientation data (for example, the angle with which the rifle is oriented with respect to the horizon as measured by accelerometers integrated into the mobile computer processing device). From such ballistics data, windage and elevation dimensions to achieve a point of impact may be calculated with respect to the rifle scope zero 1706. Using information acquired during the display calibration process discussed above, an image of a projected point of impact 1904 may be represented on the display 1702 of the mobile computer processing device 1300 in conjunction with images of the target 1902 and other objects appearing in the sight picture 1704. The image displayed to represent the point of impact may take any number of shapes and colors. In one embodiment, the point of impact may be represented by an illuminated red-colored point having a diameter approximately the width of a subtension of the optical sight.

In one embodiment, one or more ballistics variables data are continuously collected or periodically collected, and processed by the MBPDS to provide continuous or periodic real-time updates to the targeting solution displayed to the user. For example, the MBPDS may periodically collect wind data from a wind sensor mounted to the computer processing device, and utilize such wind data to calculate updated ballistics solutions. The MBPDS is configured to utilize such updated ballistics solutions to in turn update the targeting solution displayed to the user. More specifically, the MBPDS is configured to continuously or periodically update the position of the point of impact image on the display as environmental conditions change in real-time. Other variables associated with the ballistics solution calculation may change over a period of time, which will result in changes to the display of the targeting solution (position of the point of impact).

In one embodiment, the camera of the mobile computer processing device of the MBPDS may be utilized to record objects in the sight picture, as well as images presented on the display of the device. As discussed above, a recording icon 1718 may be selected by a user to trigger the initiation of such a recording. In alternate embodiments, accelerometers integrated into the mobile computer processing device may be configured to collect data associated with movement of the device. Such movement data may then be continuously processed and analyzed by the MBPDS to recognize movement characteristics associated with the discharge of a firearm.

In such an embodiment, the MBPDS may be configured to collect positional data associated with the rifle zero and calculated point of impact, and to record such positional data at a time just prior to the discharge of the rifle, and at the time of discharge (which is ascertained from data collected and processed from one or more accelerometers). From such positional information, user movement error data (unwanted movement by a user during the process of taking a shot) can be calculated and stored during post-shot processing. In this manner, data associated with movement by a user during the process of discharging a firearm can be collected and processed for later use by the MBPDS.

For example, in one embodiment, if a statistically significant and repeated pattern of recoil-induced movement error is demonstrated by a user, data associated with such movement error can be utilized to modify the displayed point of impact for a particular user, allowing for more accurate shot placement. In this manner, a user's movement error can be accounted for and offset by modifying the calculation of a targeting solution (the point of impact displayed may be moved to account for expected user error movement). The collection of recording data associated with the display just prior to, and during the discharge of the firearm, can be utilized in training the user to more make more accurate shots as shooting behavioral patterns may be evident from such recordings.

In alternate embodiments of the MBPDS, the mobile computer processing device may be removably mounted to a range finding device (also referred to as a rangefinder) as discussed above. In such an embodiment, the mobile computer processing device may be mounted directly to the range finding device or alternatively, a mounting adapter which is in turn mounted to a range finding device in a manner similar to that described above with respect to spotting scopes and rifle scopes. In such an embodiment, the MBPDS will calculate and display ballistics and targeting solutions in the manner described above with respect to scopes with one exception. Namely, instead of relying solely on data derived from GPS-acquired geographic information to calculate positional and range data associated with the target, such an embodiment will also be capable of acquiring positional and range data associated with the target from the range finding device. In one such embodiment, a communications link may be established, as discussed above, between the range finding device and the mobile computer processing device, to communicate positional and range data associated with the target from the range finding device to the mobile computer processing device.

In other such embodiments in which an MBPDS mobile computer processing device is mounted to a range finding device, image recognition technology may be utilized to ascertain range information presented on the display of the range finding device. For example, with reference to FIG. 19, were such an MBPDS mobile computer processing device mounted to a range finding device, the depiction presented in FIG. 19 may be an exemplary representation of the display of the MBPDS mobile computer processing device having a camera aligned to collect images transmitted by the range finding device. In such an embodiment, the range data viewable through the range finding device may be viewable 1724 on the display of the mobile computer processing device. Image recognition technology may be utilized to ascertain the range data by scanning and analyzing the range data appearing on the display of the mobile computer processing device. Such range data may be utilized in processing a ballistics and/or targeting solution as discussed above. By using such range data in conjunction with compass data associated with the direction of a target with respect to the mobile computer processing device, vector analysis may be utilized by the mobile computer processing device to calculate the position of the target with respect to the mobile computer processing device. Such a capability of an embodiment of the MBPDS would make it unnecessary for a user to ascertain positional data associated with a target by acquiring GPS positional data at the location of the target.

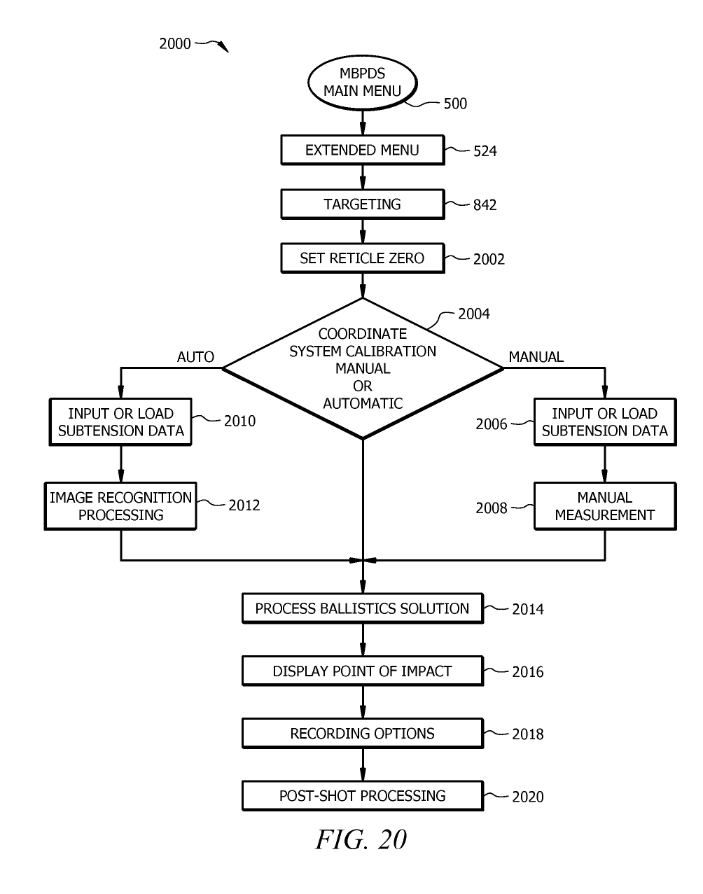

Referring now to FIG. 20, a process flow diagram illustrating steps performed by an embodiment of the mobile ballistics processing and display system for the processing and display of a targeting solution. In one embodiment, the targeting functionality 842 of the MBPDS as described above may be accessed by a user navigating the main menu 500 and extended menu 524 sub-menu as shown on the graphical user interface (see FIG. 4 and FIG. 8) presented on the display of the mobile computer processing device. Using the processes described above with respect to FIGS. 1, 6 and 7, ballistics variable data may be inputted, downloaded, or otherwise acquired by the MBPDS as needed to be capable of calculating a ballistics solution for a particular target. After mounting the computer processing device to an optical sight, the first step of calibrating the display of the MBPDS is achieved by zeroing 2002 the virtual reticle, thereby associating a position on the coordinate system of the display with the zero of the reticle of the optical sight (the intersection of the sight's reticle crosshairs). Next, a second step of calibrating the coordinate system 2004 of the display occurs. If manually calibrated, the user may input or otherwise load 2006 subtension dimensions into the MBPDS. Next, the user may utilize virtual calipers to record or measure the position of the subtension edges with respect to the coordinate system of the display. Using such measurements, along with the known subtension dimensions, units of the coordinate system of the display may be equated to actual distances at the target location for a particular target range. Automatic calibration of the display coordinate system may occur following the inputting of subtension data 2010 through the use of image recognition technology 2012 as discussed above.

Still referring to FIG. 20, real-time and static ballistics variables may be processed 2014 to calculate a ballistics solution and more particularly, windage and elevation dimensions by which a point of impact may be calculated with respect to the rifle zero point. Using such windage and elevation dimensions, and information derived during the calibration process, a point of impact may be shown 2016 on the display. Users of the MBPDS will be given the option 2018 to manually initiate and terminate recording sessions of the display. In alternate embodiments, recordings may be initiated by the sensing of accelerometers of certain movements indicative of the discharge of a firearm. In embodiments of the MBPDS, post-shot processing 2020 may include the collection and processing of positional data associated with user error in the taking of a shot, and the utilization of such data to modify the position of the display of the point of impact to correct for such error.

It should be noted that the description of the present invention has been presented for purposes of illustration and description, and is not intended to be exhaustive or limited to the invention in the form disclosed. Many modifications and variations will be apparent to those of ordinary skill in the art. The preferred embodiment appearing in the drawings was chosen and described in order to best explain the principles of the invention, the practical application, and to enable others of ordinary skill in the art to understand the invention for various embodiments with various modifications as are suited to the particular use contemplated. It will be understood by one of ordinary skill in the art that numerous variations will be possible to the disclosed embodiments without going outside the scope of the invention as disclosed in the claims. Moreover, it should be noted that uses of the phrase “the present invention” within this disclosure are not intended to limit or otherwise restrict the scope of the invention(s) disclosed and claimed by the inventor, but said phrase is merely intended to refer to certain examples of embodiments of the invention(s).

What is claimed is:

1. A ballistics processing and targeting display system, said system comprising:
(a) a central processor unit;
(b) an imaging sensor; and
(c) at least one display screen communicatively connected to said central processor unit,
wherein when said system is coupled to a viewing instrument, said imaging sensor is configured to receive images transmitted from said viewing instrument, said images transmitted from said viewing instrument comprising one or more images of marking features associated with said viewing instrument,
wherein data associated with dimensional attributes of said marking features is ascertained and stored by the system,
wherein said central processor unit processes said data associated with said dimensional attributes to calibrate a display screen coordinate system.

2. The ballistics processing and targeting display system of claim 1, wherein said system is physically coupled to said viewing instrument.

3. The ballistics processing and targeting display system of claim 1, wherein said system is wirelessly coupled to said viewing instrument.

4. The ballistics processing and targeting display system of claim 1, wherein said viewing instrument comprises a scope having a reticle.

5. The ballistics processing and targeting display system of claim 4, wherein said central processor unit is configured to receive data associated with one or more ballistics variables associated with a projectile, said central processor unit being further configured to process said data associated with one or more ballistics variables associated with a projectile to generate data associated with projected in-flight characteristics corresponding to said projectile.

6. The ballistics processing and targeting display system of claim 5, wherein said central processor unit is configured to process said data associated with said projected in-flight characteristics corresponding to said projectile to generate a depiction of a projected point of impact of said projectile on said display screen.

7. The ballistics processing and targeting display system of claim 4 wherein said marking features associated with said viewing instrument comprises one or more scope reticle subtensions.

8. The ballistics processing and targeting display system of claim 6, wherein said system is configured to record and store a plurality of said images transmitted from said viewing instrument.

9. The ballistics processing and targeting display system of claim 8 wherein said system is further configured to record and store a plurality of images associated with said depiction of a projected point of impact of said projectile on said display screen.

10. The ballistics processing and targeting display system of claim 9, further comprising one or more accelerometers electronically connected to said central processor unit, said system utilizing movement information received from said one or more accelerometers to initiate a recording of said plurality of said images transmitted from said viewing instrument and said plurality of images associated with said depiction of a projected point of impact of said projectile on said display screen.

11. A ballistics processing and targeting display system, said system comprising:
(a) a central processor unit;
(b) an imaging sensor; and
(c) at least one display screen communicatively connected to said central processor unit,
wherein when said system is coupled to a range finding device, said imaging sensor is configured to receive images transmitted from said range finding device, said images transmitted from said viewing instrument comprising one or more images of range information generated by said viewing instrument,
wherein said central processor unit recognizes and analyzes said one or more images of range information generated by said viewing instrument to derive numerical values associated with said range information.

12. The ballistics processing and targeting display system of claim 11, wherein said central processor unit is configured to receive data associated with one or more ballistics variables associated with a projectile, said central processor unit being further configured to process said data associated with one or more ballistics variables associated with a projectile and said numerical values associated with said range information, to generate data associated with projected in-flight characteristics corresponding to said projectile.

13. The ballistics processing and targeting display system of claim 12, wherein said central processor unit is configured to process said data associated with projected in-flight characteristics corresponding to said projectile to generate a depiction of a projected point of impact of said projectile on said display screen.

14. The ballistics processing and targeting display system of claim 11, wherein said system is physically coupled to said viewing instrument.

15. The ballistics processing and targeting display system of claim 11, wherein said system is wirelessly coupled to said viewing instrument.

16. The ballistics processing and targeting display system of claim 13, wherein said system is configured to record and store a plurality of said images transmitted from said viewing instrument.

17. The ballistics processing and targeting display system of claim 16 wherein said system is further configured to record and store a plurality of images associated with said depiction of a projected point of impact of said projectile on said display screen.

18. The ballistics processing and targeting display system of claim 17, further comprising one or more accelerometers electronically connected to said central processor unit, said system utilizing movement information received from said one or more accelerometers to initiate a recording of said plurality of said images transmitted from said viewing instrument and said plurality of images associated with said depiction of a projected point of impact of said projectile on said display screen.
